(19) United States
(12) Patent Application Publication
(10) Pub. No.: US 2014/0032173 A1
(43) Pub. Date: Jan. 30, 2014

(54) INFORMATION PROCESSING APPARATUS, AND MONITORING METHOD

(71) Applicant: FUJITSU LIMITED, Kawasaki-shi (JP)

(72) Inventors: Kohei KIDA, Kawasaki (JP); Hirokazu SUGANUMA, Yokohama (JP)

(73) Assignee: FUJITSU LIMITED, Kawasaki-shi (JP)

(21) Appl. No.: 14/043,907

(22) Filed: Oct. 2, 2013

Related U.S. Application Data
(63) Continuation of application No. PCT/JP2011/060253, filed on Apr. 27, 2011.

(51) Int. Cl. G01N 35/00

(52) U.S. Cl. CPC G01N 35/00
USPC 702/183

(57) ABSTRACT

A time measurement unit measures a waiting time for information that is expected to be received from a target device connected via a network. Upon expiration of a time limit without receiving the expected information, a querying unit sends a query to a monitoring device monitoring the target device to request operational status information of the target device. Based on the operational status information received from the monitoring device, a determination unit determines whether the target device is faulty or there is a fault in the network between the computer and target device.

### CROSS-REFERENCE TO RELATED APPLICATION

This application is a continuation application of International Application PCT/JP2011/060253 filed on Apr. 27, 2011 which designated the U.S., the entire contents of which are incorporated herein by reference.

### FIELD

The embodiments discussed herein relate to an information processing apparatus and a monitoring method.

### BACKGROUND

One device in a system may be configured to supervise the operation of another device. For example, the monitoring device keeps track of whether the monitored device (or target device) is operating properly, by checking the latter's response to polling actions or by observing heartbeat signals that the target device generates periodically.

Generally the monitoring device is designed to detect a failure in the target device under monitoring when a response timeout occurs or when the heartbeat stops. However, such response timeout or lost heartbeat may be encountered even in normal circumstances. One example is the case where a target device is rebooted to synchronize its internal realtime clock with a Network Time Protocol (NTP) server. In this exemplary case, the target device is unable to respond to the polling from the monitoring device until the rebooting is completed. The consequent lack of response or heartbeat does not necessarily mean the presence of a problem in the target device. False detection of failures in such cases would degrade the reliability of operation monitoring.

According to one proposed technique for ensuring the reliability of operation monitoring, the target device sends a previous notice to the monitoring device before its functions come to a temporary halt, so that the monitoring device can stop monitoring in advance. For example, the target device may inform a call center device of its own power on/off status, so that the call center device starts or stops the monitoring operation accordingly. The proposed technique enables more accurate determination of whether the target device is operating properly. See, for example, Japanese Laid-open Patent Publication No. 2005-309643.

The target device may appear to be inoperative when there is a fault in its network connection with the monitoring device. In spite of the fact that the target device has no problem in itself, the monitoring device could misconstrue the fact as being a failure of the target device. The above-noted conventional technique does not provide solutions for this issue, allowing degradation of the reliability of operation monitoring.

### SUMMARY

According to an aspect of the embodiments to be discussed herein, there is provided a computer-readable storage medium storing a program which causes a computer to perform a procedure including: measuring a waiting time for information that is expected to be received from a target device connected via a network; sending, upon expiration of a time limit without receiving the expected information, a query to a monitoring device monitoring the target device to request operational status information of the target device; and determining whether the target device is faulty or there is a fault in the network between the computer and target device, based on the operational status information received from the monitoring device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary functional structure of an information processing apparatus according to a first embodiment;

FIG. 2 is a sequence diagram illustrating a first exemplary procedure according to the first embodiment;

FIG. 3 is a sequence diagram illustrating a second exemplary procedure according to the first embodiment;

FIG. 4 is a sequence diagram illustrating a third exemplary procedure according to the first embodiment;

FIG. 5 illustrates an exemplary system configuration according to a second embodiment;

FIG. 6 illustrates an exemplary hardware configuration of a console unit;

FIG. 7 is a block diagram illustrating three devices configured to control and monitor one another;

FIG. 8 is a block diagram illustrating an example of what functions are included in each device;

FIG. 9 illustrates an exemplary data structure of a monitoring status storage unit;

FIG. 10 illustrates an exemplary data structure of an error log storage unit;

FIG. 11 illustrates the format of HLC command frames;

FIG. 12 illustrates the format of HLC response frames;

FIG. 13 is a sequence diagram illustrating a first exemplary procedure of operation monitoring;

FIG. 14 is a sequence diagram illustrating a second exemplary procedure of operation monitoring;

FIG. 15 illustrates an exemplary error log produced in the case of a timeout during regular monitoring;

FIG. 16 is a sequence diagram illustrating a third exemplary procedure of operation monitoring;

FIG. 17 illustrates an exemplary error log produced in the case of network reconnection failure;

FIG. 18 is a sequence diagram illustrating a fourth exemplary procedure of operation monitoring;

FIG. 19 illustrates an exemplary error log produced in the case of reboot failure;

FIG. 20 is a sequence diagram illustrating a fifth exemplary procedure of operation monitoring;

FIG. 21 illustrates an exemplary error log produced in the case of an HLC communication error;

FIG. 22 is a flowchart illustrating a procedure of active regular monitoring;

FIG. 23 is a flowchart illustrating a procedure of passive regular monitoring;

FIG. 24 is the first half of a flowchart illustrating an exemplary procedure of regular monitoring management; and

FIG. 25 is the second half of the flowchart illustrating an exemplary procedure of regular monitoring management.

### DESCRIPTION OF EMBODIMENTS

Several embodiments will be described below with reference to the accompanying drawings. These embodiments may be combined with each other as long as there are no contradictions between them.

### (a) First Embodiment

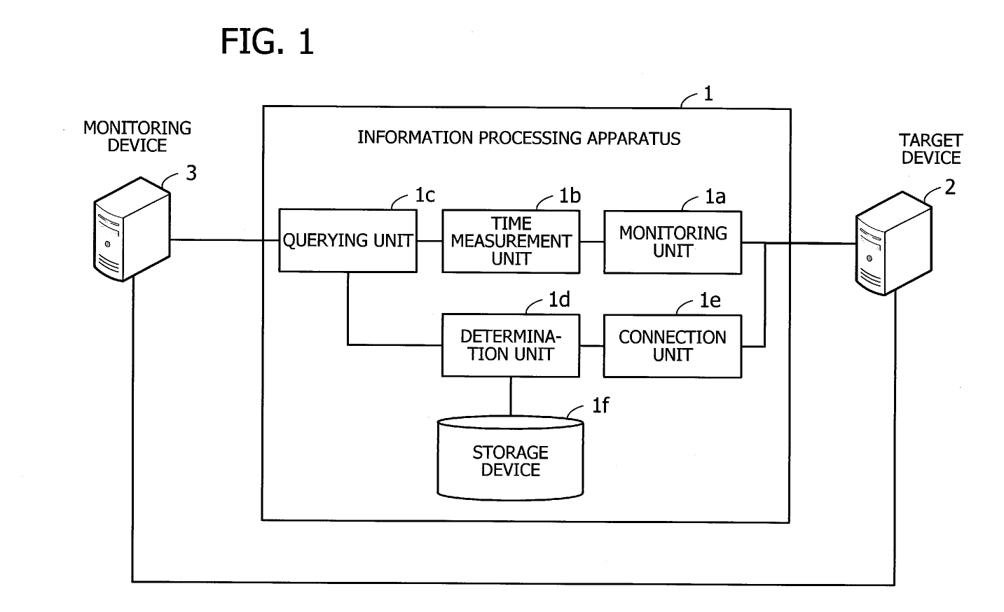

FIG. 1 illustrates an exemplary functional structure of an information processing apparatus according to a first embodiment. The first embodiment provides an information processing apparatus 1 to monitor the operation of a target device 2 connected thereto via a network. This target device 2 under monitoring is referred to as a target device. The first embodiment further involves a monitoring device 3 that also monitors the operation of the target device 2 via a network.

The illustrated information processing apparatus 1 includes a monitoring unit 1a, a time measurement unit 1b, a querying unit 1c, a determination unit 1d, a connection unit 1e, and a storage device 1f.

The monitoring unit 1a regularly monitors whether the target device 2 is operating properly. For example, the monitoring unit 1a performs regular polling of the operational status of the target device 2. When the target device 2 responds within a specific time limit, the monitoring unit 1a determines that the target device 2 is operating. When the target device 2 does not respond to the polling within the time limit, the monitoring unit 1a determines that the target device 2 is faulty.

The monitoring unit 1a may stop regular monitoring of the target device 2 when, for example, there is a regular monitoring halt command from the target device 2. In that case, the monitoring unit 1a does not resume the regular monitoring until a regular monitoring resume command is received.

The time measurement unit 1b measures a waiting time for information that is expected to be received from the target device 2. For example, the time measurement unit 1b measures the time elapsed since a regular monitoring halt command is received by the monitoring unit 1a until a regular monitoring resume command is received by the same.

The above waiting time is compared with a specific time limit parameter defined for reception of the information. When the time limit is reached without receiving the expected information, the querying unit 1c sends a query to the monitoring device 3 to request information about the current operational status of the target device 2, which has been monitored by the monitoring device 3. For example, the querying unit 1c sends such a query to the monitoring device 3 when no regular monitoring resume command arrives before the time limit of a regular monitoring resume command is reached.

The monitoring device 3 returns a response to the query, which indicates the operational status of the target device 2. Based on this status information, the determination unit 1d determines whether there is a failure in the target device 2 itself or a failure in the network between the information processing apparatus and the target device 2. For example, the determination unit 1d suspects a network fault when the response from the monitoring device 3 indicates that the target device 2 is operating properly. The determination unit 1d recognizes, on the other hand, that the target device 2 is faulty when the response from the monitoring device 3 indicates a problem in the target device 2 itself.

In the case where a network fault is suspected, the determination unit 1d may request the connection unit 1e to attempt to set up a network connection with the target device 2. When this attempt by the connection unit 1e is unsuccessful, the determination unit 1d concludes that there is a network fault associated with the target device 2. When, on the other hand, the network connection is successful, the determination unit 1d withdraws its previous determination of a network fault.

When it is finally found that either the target device 2 or network is faulty, the determination unit 1d records its conclusion in a storage device 1f. The storage device 1f provides a storage space for such determination results of the determination unit 1d.

The connection unit 1e handles a network connection to communicate with the target device 2. For example, the connection unit 1e attempts to set up a network connection to reach the target device 2 when so requested by the determination unit 1d. The connection unit 1e informs the determination unit 1d of whether it has successfully established a network connection with the target device 2.

The above monitoring unit 1a, time measurement unit 1b, querying unit 1c, determination unit 1d, and connection unit 1e may be implemented as part of the functions of a central processing unit (CPU) in the information processing apparatus 1. Also, the above storage device 1f may be implemented as a storage space of a random access memory (RAM) or hard disk drive (HDD) in the information processing apparatus 1.

It is further noted that the lines interconnecting the functional blocks in FIG. 1 are only an example, and some communication paths may be omitted for simplicity purposes. The person skilled in the art would appreciate that there may be other communication paths in actual implementations.

The next section provides an example of how the proposed information processing apparatus 1 locates a problem in the system according to the first embodiment. Specifically, it is assumed that the information processing apparatus 1 performs regular monitoring of a target device 2. The target device 2 sends a regular monitoring halt command to the information processing apparatus 1 before the target device 2 begins to reboot itself, so that the information processing apparatus 1 temporarily stops regular monitoring during the process of rebooting. The information processing apparatus 1 is configured to detect a failure when no regular monitoring resume command is received from the target device 2 within a predetermined resume timeout limit after the reception of the above regular monitoring halt command.

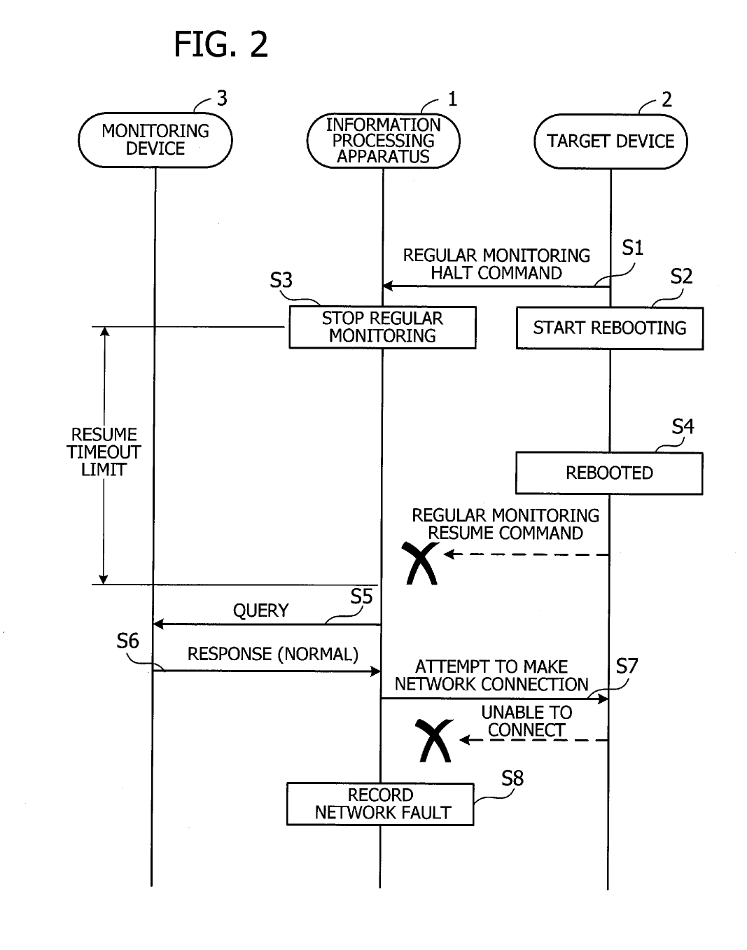

FIG. 2 is a sequence diagram illustrating a first exemplary procedure according to the first embodiment. Each operation in FIG. 2 is described below in the order of step numbers.

(Step S1) Before rebooting itself, the target device 2 sends a regular monitoring halt command to the information processing apparatus 1.

(Step S2) The target device 2 starts rebooting itself.

(Step S3) In response to the above regular monitoring halt command, the monitoring unit 1a in the information processing apparatus 1 stops regular monitoring of the target device 2. The time measurement unit 1b, on the other hand, starts to count the time elapsed since the regular monitoring halt command is received.

(Step S4) The target device 2 completes its rebooting. It is assumed in the example of FIG. 2 that the target device 2 is unable to send the information processing apparatus 1a regular monitoring resume command for some reason.

(Step S5) In the information processing apparatus 1, the time measurement unit 1b detects expiration of a resume timeout limit for regular monitoring. That is, no regular monitoring resume command is received within a prescribed time limit after the reception of the regular monitoring halt command. This timeout event causes the querying unit 1c to send a query to the monitoring device 3 to request information about the operational status of the target device 2.

By sending such a query to the monitoring device 3, the information processing apparatus 1 makes sure whether the target device 2 is really down or not. It is noted that the monitoring device 3 is connected to the target device 2 via another communication path that is separate from the one between the information processing apparatus 1 and target device 2. For this reason, the target device 2, if operating properly, would be able to communicate with the monitoring device 3, even when the information processing apparatus 1 is unable to reach the target device 2.

(Step S6) In response to the query from the information processing apparatus 1, the monitoring device 3 returns the status information of the target device 2 in question. The example of FIG. 2 assumes that the information processing apparatus 1 receives a normal response indicating that the target device 2 is operating properly.

(Step S7) Upon receipt of the above response from the monitoring device 3, the querying unit 1c in the information processing apparatus 1 forwards the information to the determination unit 1d. Since the target device 2 is operating properly, the determination unit 1d determines that what is actually happening with the target device 2 is a network fault, and thus requests the connection unit 1e to make a network connection to the target device 2. Upon request, the connection unit 1e executes a network connection process to reach the target device 2. It is assumed in the example of FIG. 2 that the connection unit 1e fails to make a network connection.

(Step S8) The connection unit 1e informs the determination unit 1d of its failed attempt of network connection. Because the attempt of network connection has been failed in spite of the fact that the target device 2 is operating properly, the determination unit 1d concludes that there is a network fault between the information processing apparatus 1 and the target device 2. The determination unit 1d then stores a record of this network fault in the storage device 1f.

The information processing apparatus 1 may otherwise be able to set up a network connection with the target device 2. When this is the case, the information processing apparatus 1 operates in the following way.

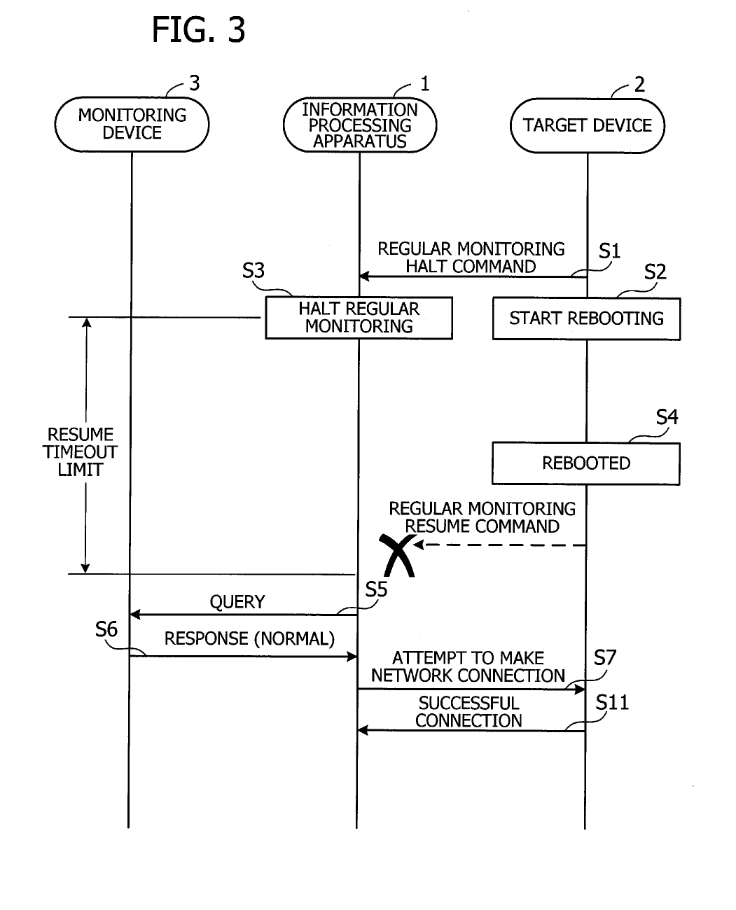

FIG. 3 is a sequence diagram illustrating a second exemplary procedure according to the first embodiment. The operation seen in FIG. 3 may be described in the order of step numbers. The following description, however, focuses on one step that is different from the steps discussed in FIG. 2. See the previous description for the other steps having like step numbers.

Now in the example of FIG. 3, step S7 results in a successful network connection.

(Step S11) The connection unit 1e informs the determination unit 1d of the successful network connection. Because of this success in spite of no reception of regular monitoring resume commands, the determination unit 1d concludes that the target device 2 has been rebooted properly and is ready for communication over the network. The determination unit 1d produces, in this case, no particular records for the storage device 1f since the target device 2 has no problems in itself. Accordingly, the monitoring unit 1a is allowed to resume the regular monitoring of the target device 2.

As another possible event, the rebooting of the target device 2 may end up with a failure. When this is the case, the information processing apparatus 1 and monitoring device 3 operates as follows.

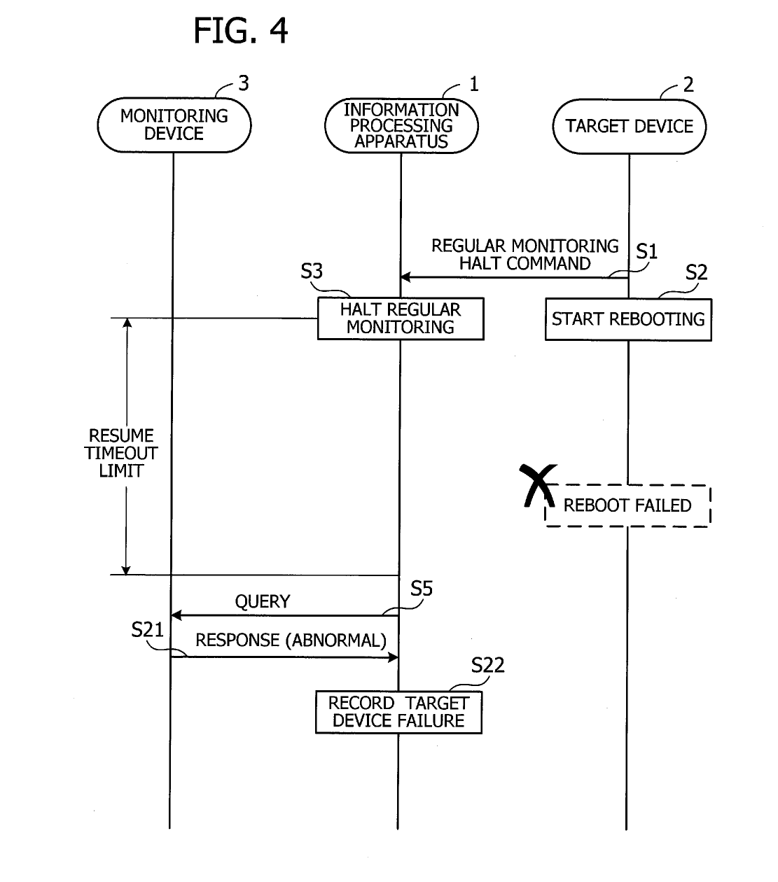

FIG. 4 is a sequence diagram illustrating a third exemplary procedure according to the first embodiment. The operation seen in FIG. 4 is described below in the order of step numbers. The following description, however, focuses on a couple of steps that are different from the steps discussed in FIG. 2. See the previous description for the other steps having like step numbers.

(Step S21) In response to the query from the information processing apparatus 1, the monitoring device 3 returns a response indicating the status of the target device 2. In the example of FIG. 4, the response to the information processing apparatus 1 suggests abnormality of the target device 2.

(Step S22) Upon receipt of the above response from the monitoring device 3, the querying unit 1c in the information processing apparatus 1 forwards the information to the determination unit 1d. The determination unit 1d thus recognizes that the target device 2 has some abnormality, and thus stores a record in the storage device 1f to indicate that the target device 2 is faulty.

As can be seen from the above, the first embodiment is configured to monitor one target device 2 by using two devices, i.e., the information processing apparatus 1 and monitoring device 3. Even in the case of disruption of communication between the target device 2 and information processing apparatus 1, the information processing apparatus 1 still finds the target device 2 to be operational, as long as the monitoring device 3 can communicate with the target device 2. This feature makes it possible to isolate the faults more accurately, i.e., whether the disruption of communication with the target device 2 is caused by a failure of the target device 2 itself or by a failure in the network.

The first embodiment also causes the information processing apparatus 1 to set up a network connection with the target device 2, when it is unable to receive expected information from the target device 2 despite the fact that the target device 2 is operating properly. If this attempt of connection is successful, the information processing apparatus 1 outputs nothing about the network, thus avoiding overly sensitive error detection.

The amount of man-hours for maintenance and troubleshooting is reduced by more accurately discriminating whether the target device 2 is operating properly. That is, indication of many errors would make it difficult for the maintenance people to figure out which one is really relevant to the current problem. As noted above, the first embodiment avoids overly sensitive error detection, which alleviates such burden on the maintenance people.

### (b) Second Embodiment

This section describes a second embodiment, which enables one managing device in a multi-cluster system to monitor other devices constituting the system. A multi-cluster system includes a plurality of clusters organized as a single system.

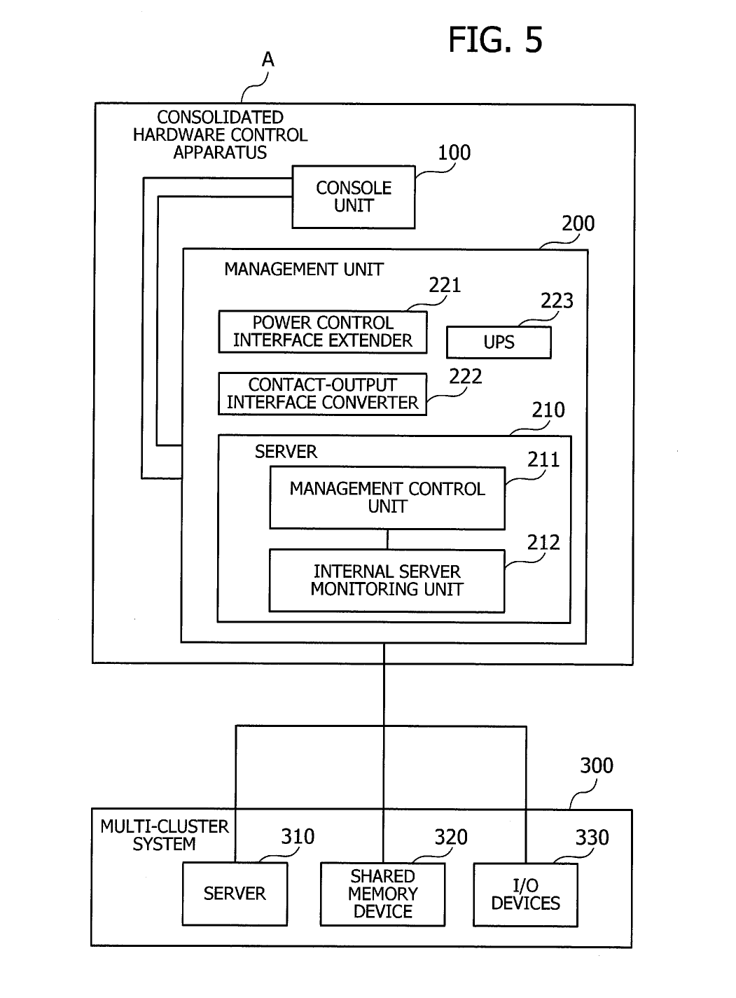

FIG. 5 illustrates an exemplary system configuration according to the second embodiment. The second embodiment includes a consolidated hardware control apparatus A to manage a multi-cluster system 300. The illustrated multi-cluster system 300 includes a large-scale server 310, a shared memory device 320, and I/O devices 330. The server 310, may actually be configured as, for example, a system of multiple clusters. The shared memory device 320 is a memory subsystem configured for sharing by the clusters constituting the server 310. The I/O devices 330 support input and output of data to and from the server 310.

The consolidated hardware control apparatus A includes a console unit 100 and a management unit 200. The console unit 100 controls the user interface. The management unit 200 manages the multi-cluster system 300 and console unit 100. Specifically, the management unit 200 is connected to the server 310, shared memory device 320, and I/O device 330 in the multi-cluster system 300 via, for example, a power control interface. The power control interface permits the management unit 200 to control the power supply of each device in the multi-cluster system 300. The management unit 200 is also connected to the console unit 100 via a plurality of local area network (LAN) interfaces.

The management unit 200 includes, among others, a server 210, a power control interface extender 221, a contact-output interface converter 222, and an uninterruptible power supply (UPS) 223. The power control interface extender 221 enables the power control interface to extend to the multi-cluster system 300. The contact-output interface converter 222 performs interface conversion for contact output signals of the multi-cluster system 300. The UPS 223 ensures supply of electricity to the consolidated hardware control apparatus A and multi-cluster system 300 for a certain time, even when their main power line is down.

The server 210 includes a management control unit 211 and an internal server monitoring unit 212. The management control unit 211 and internal server monitoring unit 212 are implemented in separate modules and configured to communicate with each other via, for example, a LAN connection.

The management control unit 211 controls the management unit 200 in its entirety. For example, the management control unit 211 may be implemented as part of a control program that runs on the operating system (OS) of the management unit 200. This program, when executed by a CPU of the management control unit 211, provides the functions of the management control unit 211. The internal server monitoring unit 212 monitors the operational status of, for example, hardware devices in the server 210. For example, the internal server monitoring unit 212 monitors activities of CPU, memory, and hard disk drives (HDDs), as well as watching fan speeds, device temperatures, and other internal parameters of the server 210 itself.

The internal server monitoring unit 212 may be implemented as part of a control program executed by a CPU of the internal server monitoring unit 212. The internal server monitoring unit 212 may operate with commands that are entered through the console unit 100, for example. In addition to such command-line inputs of the console unit 100, the internal server monitoring unit 212 may handle commands that are entered to a web browser of a terminal device (not illustrated) through a network connection. In the latter case, the requesting terminal device communicates with the internal server monitoring unit 212 via a secure channel using cryptographic communication techniques such as the Secure Shell (SSH) and Secure Socket Layer (SSL).

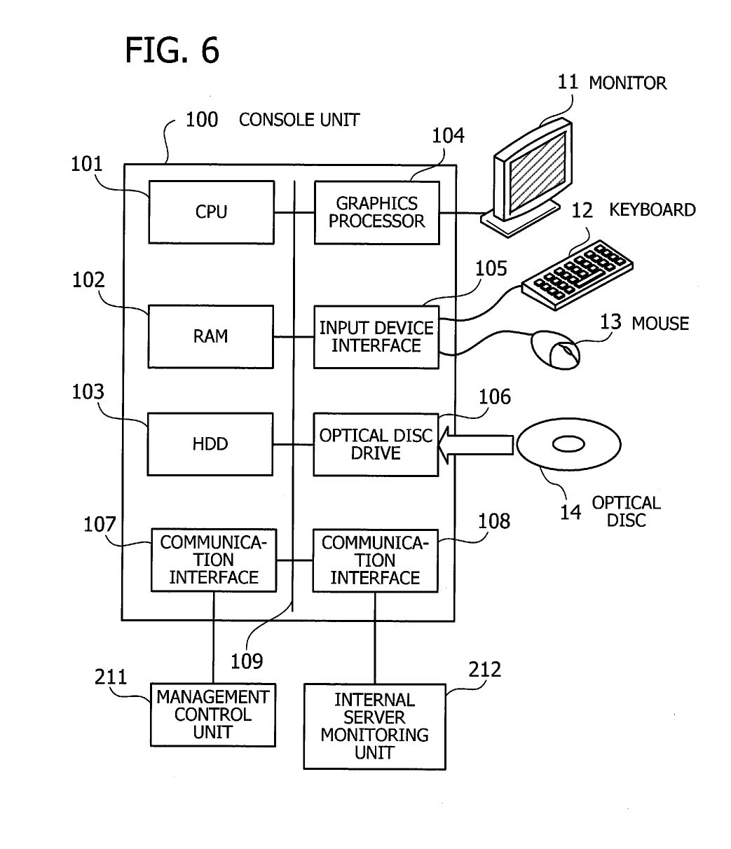

FIG. 6 illustrates an exemplary hardware configuration of the console unit 100. A CPU 101 is included to control the entire device of the console unit 100. Connected to this CPU 101 via a bus 109 are a random access memory (RAM) 102 and other various devices and interfaces.

The RAM 102 serves as primary storage of the console unit 100. Specifically, the RAM 102 is used to temporarily store at least some of the operating system (OS) programs and application programs that the CPU 101 executes, in addition to other various data objects that the CPU 101 manipulates at runtime. Other devices on the bus 109 include an HDD 103, a graphics processor 104, an input device interface 105, an optical disc drive 106, and two communication interfaces 107 and 108.

The HDD 103 writes and reads data magnetically on its internal platters. The HDD 103 serves as secondary storage of the console unit 100 to store program and data files of the operating system and applications. Flash memory and other semiconductor memory devices may also be used as secondary storage, similarly to the HDD 103.

The graphics processor 104, coupled to a monitor 11, produces video images in accordance with drawing commands from the CPU 101 and displays them on a screen of the monitor 11. The monitor 11 may be, for example, a cathode ray tube (CRT) display or a liquid crystal display.

The input device interface 105 is connected to input devices such as a keyboard 12 and a mouse 13 and supplies signals from those devices to the CPU 101. The mouse 13 is a pointing device, which may be replaced with other kinds of pointing devices such as touchscreen, tablet, touchpad, and trackball.

The optical disc drive 106 reads out data encoded on an optical disc 14, by using laser light or the like. The optical disc 14 is a portable data storage medium, the data recorded on which can be read as a reflection of light or the lack of the same. More specifically, the optical disc 14 may be a digital versatile disc (DVD), DVD-RAM, compact disc read-only memory (CD-ROM), CD-Recordable (CD-R), or CD-Rewritable (CD-RW), for example.

One communication interface 107 is coupled to the management control unit 211 via a LAN to exchange data therewith. The other communication interface 107 is coupled to the internal server monitoring unit 212 via another LAN to exchange data therewith.

The above-described hardware platform may be used to realize the processing functions of the second embodiment. The hardware configuration discussed above for the console unit 100 may similarly be applied to the management control unit 211 and internal server monitoring unit 212. The exception is that the management control unit 211 and internal server monitoring unit 212 may not necessarily include display devices (monitors) or input devices (e.g., keyboard, mouse). The computer hardware configuration of FIG. 6 may also be applied to the foregoing information processing apparatus 1, target device 2, and monitoring device 3 in the first embodiment.

According to the second embodiment, the console unit 100, management control unit 211, and internal server monitoring unit 212 are implemented as separate modules. The console unit 100, management control unit 211, and internal server monitoring unit 212 are configured to perform regular monitoring of one another. That is, each device supervises other two devices on a regular basis. The regular monitoring watches the behavior of a device being monitored (target device) via a LAN and determines whether the target device in question is operating properly. This type of operation monitoring is referred to as, for example, “LAN path monitoring.”

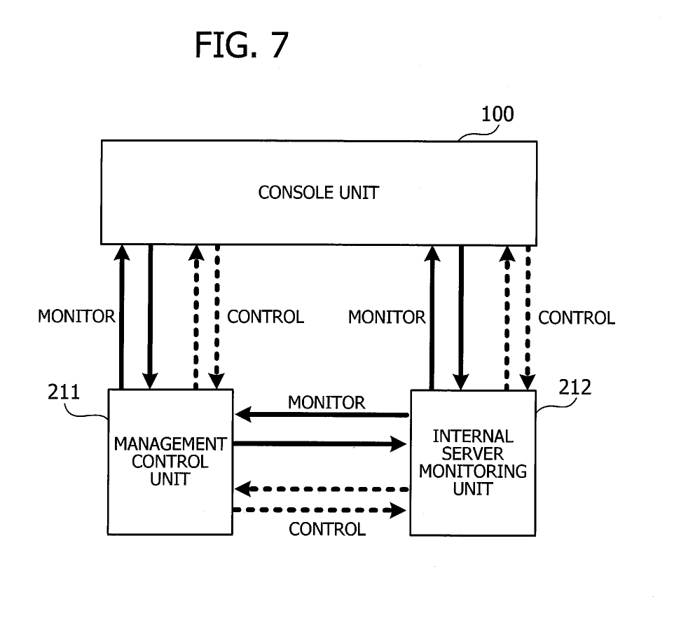

FIG. 7 is a block diagram illustrating three devices configured to control and monitor one another. Each solid arrow in FIG. 7 represents a relationship in which one device monitors another device, the arrow head pointing to the monitored device and the other end indicating the monitoring device. Each dotted arrow in FIG. 7, on the other hand, represents a relationship in which one device controls another device, the arrow head pointing to the controlled device and the other end indicating the controlling device.

The console unit 100 monitors the management control unit 211 and internal server monitoring unit 212 via LAN. The console unit 100 also controls the management control unit 211 and internal server monitoring unit 212 via LAN. The management control unit 211 monitors the console unit 100 and internal server monitoring unit 212 via LAN. The management control unit 211 also controls the console unit 100 and internal server monitoring unit 212 via LAN. The internal server monitoring unit 212 monitors the console unit 100 and management control unit 211 via LAN. The internal server monitoring unit 212 also controls the console unit 100 and management control unit 211 via LAN.

As can be seen from the above, the console unit 100, management control unit 211, and internal server monitoring unit 212 are configured to mutually monitor their operation on a regular basis, besides being capable of controlling each other. The second embodiment improves the reliability of operation monitoring by using mutual control functions of the devices. For example, the console unit 100, management control unit 211, and internal server monitoring unit 212 may reboot one another by sending commands through their mutual control functions. They may also command each other to stop regular monitoring during the rebooting process.

The console unit 100, management control unit 211, and internal server monitoring unit 212 may detect a network connection failure in one of their communication links. In that case, the detecting device attempts to make a network connection again.

The second embodiment provides a specific example of how the console unit 100, management control unit 211, and internal server monitoring unit 212 supervise each other when one of them is rebooted. A device may be rebooted in the case of, for example, synchronizing its internal clock with an NTP server. Suppose now that, for example, the internal server monitoring unit 212 is to reboot itself to synchronize its internal clock with an NTP server. This rebooting may be initiated by a command from the management control unit 211.

When sending a reboot command to the internal server monitoring unit 212, the management control unit 211 reconfigures itself to prevent error detection of the LAN path to the internal server monitoring unit 212. The console unit 100, on the other hand, is not aware of the upcoming rebooting of the internal server monitoring unit 212. This means that the console unit 100 could detect LAN path monitoring errors due to the rebooting command to the internal server monitoring unit 212 unless some measures are taken to stop monitoring of the internal server monitoring unit 212. According to the second embodiment, the rebooting internal server monitoring unit 212 sends in advance a regular monitoring halt command to other monitoring devices (e.g., console unit 100 in this case) than the one that has initiated the rebooting (e.g., management control unit 211). This feature of the second embodiment prevents the console unit 100 from detecting errors when the internal server monitoring unit 212 is rebooted.

The next section describes various functions used in each device to isolate problems found during the operation monitoring.

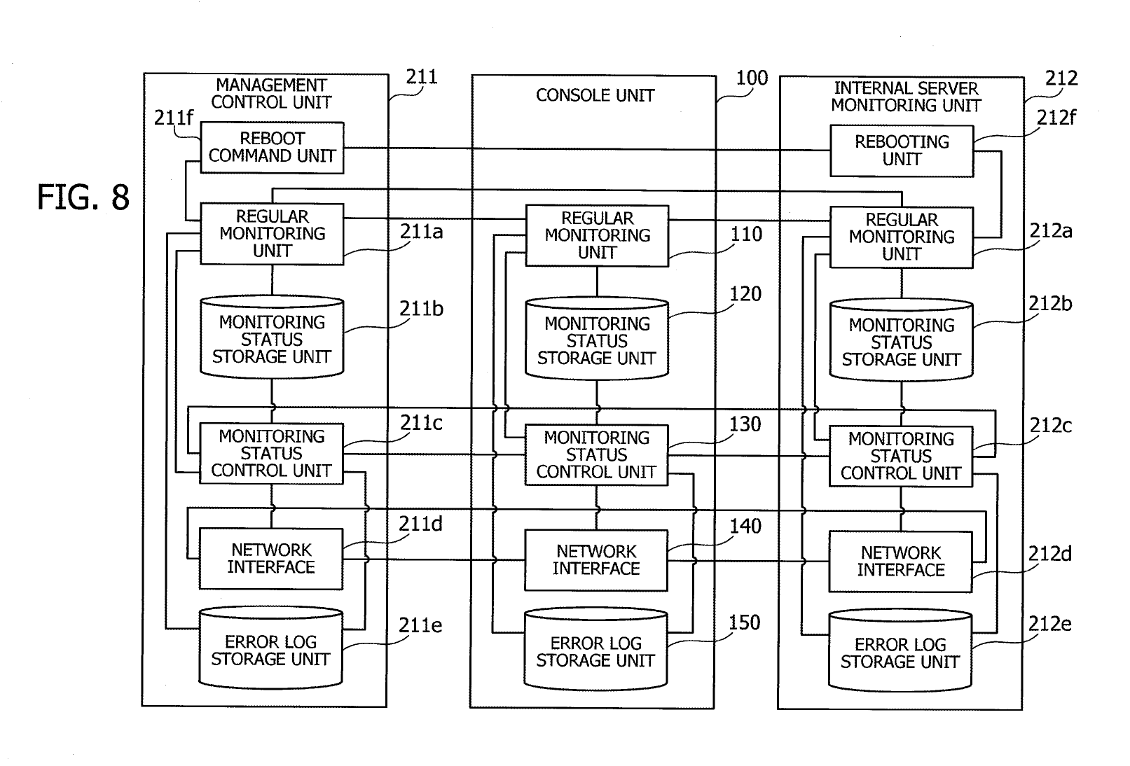

FIG. 8 is a block diagram illustrating an example of what functions are included in each device. For example, the illustrated console unit 100 includes a regular monitoring unit 110, a monitoring status storage unit 120, a monitoring status control unit 130, a network interface 140, and an error log storage unit 150.

The regular monitoring unit 110 performs regular monitoring of other devices, i.e., management control unit 211 and internal server monitoring unit 212. For example, the regular monitoring unit 110 periodically sends a regular monitoring message to each of the management control unit 211 and internal server monitoring unit 212. When a response to this regular monitoring message is received from one of the destination devices (target devices), the regular monitoring unit 110 determines that the responding target device is operating properly. When no response is received from a particular target device within a specified timeout limit of the regular monitoring, the regular monitoring unit 110 determines that there is something wrong with that target device, and thus produces an error log record of the target device in the error log storage unit 150.

The management control unit 211 and internal server monitoring unit 212 similarly send regular monitoring messages to the console unit 100. These messages are received and handled by the regular monitoring unit 110. That is, the regular monitoring unit 110 returns a response to the sender of each received regular monitoring message.

The regular monitoring unit 110 may receive a regular monitoring halt command from the management control unit 211 or internal server monitoring unit 212. In response, the regular monitoring unit 110 temporarily stops regular monitoring of the sender of that command. The regular monitoring unit 110 may also receive a regular monitoring resume command from a particular target device temporarily excluded from the regular monitoring. When this is the case, the regular monitoring unit 110 resumes regular monitoring of that target device. When there is no regular monitoring resume command from a target device temporarily excluded from the regular monitoring, and if the absence of such commands exceeds a predetermined resume timeout limit, then the regular monitoring unit 110 subjects the target device to a confirmation procedure. The regular monitoring unit 110 now notifies the monitoring status control unit 130 of which device is under confirmation. Such a target device is referred to herein as the “device under confirmation.”

The regular monitoring unit 110 further produces and stores monitoring status records in the monitoring status storage unit 120 to record the result of regular monitoring, i.e., the condition of each target device being monitored. The monitoring status records indicate, for example, “Under Monitoring,” “Monitoring in Halt,” “Response Received”, or “Monitoring Timeout” as the state of a target device. State “Under Monitoring” means that the target device in question is currently monitored. State “Monitoring in Halt” means that the regular monitoring of the target device is disabled at present. State “Response Received” means that the target device has been responding positively to the commands of regular monitoring. State “Monitoring Timeout” means that a command of regular monitoring has timed out because of no response from the target device.

The regular monitoring unit 110 cooperates with its counterparts in other devices (i.e., regular monitoring units 211a and 212a) to synchronize the data in their monitoring status storage units 120, 211b, and 212b on a regular basis. This synchronization processing permits the monitoring status storage units 120, 211b, and 212b to keep their data content in a consistent state.

As already mentioned above, the monitoring status storage unit 120 stores monitoring status records of target devices. For example, the monitoring status storage unit 120 may be implemented as part of storage space of the RAM 102 or HDD 103.

The monitoring status control unit 130 exchanges monitoring status records with the management control unit 211 or internal server monitoring unit 212. For example, the monitoring status control unit 130 receives information about a specific device under confirmation from the regular monitoring unit 110. Upon receipt of this information, the monitoring status control unit 130 sends a monitoring status request to its peer device that has been monitoring the device under confirmation. The requested device responds to this request by returning monitoring status information of the specified device under confirmation, and this response permits the monitoring status control unit 130 to determine whether the device under confirmation is really faulty. For example, the received monitoring status information may indicate that a timeout is encountered in the course of monitoring the device under confirmation. In this case, the monitoring status control unit 130 determines that the device under confirmation has a problem with itself, and thus produces an entry of the error log storage unit 150 to record the failure. In another case, the received monitoring status information may indicate that the device under confirmation is operating properly. The monitoring status control unit 130 then determines that the real problem lies in a network between the regular monitoring unit 110 and the device under confirmation. The monitoring status control unit 130 thus requests the network interface 140 to make a network connection with the device under confirmation.

The network interface 140 makes a network connection with the management control unit 211 or internal server monitoring unit 212. Specifically, the act of making a network connection is to establish an individual connection with the management control unit 211 and internal server monitoring unit 212. For example, the network interface 140 makes a network connection with a device under confirmation when so requested by the monitoring status control unit 130. The network interface 140 also makes a network connection with the management control unit 211 and internal server monitoring unit 212 upon startup of the console unit 100. In the case where an attempt of network connection with the device under confirmation ends up with an error, the network interface 140 produces an error log in the error log storage unit 150 to record the network fault.

The error log storage unit 150 is a storage place for such error logs. For example, the error log storage unit 150 may be implemented as part of storage space of the RAM 102 or HDD 103.

The management control unit 211 includes a regular monitoring unit 211a, a monitoring status storage unit 211b, a monitoring status control unit 211c, a network interface 211d, an error log storage unit 211e, and a reboot command unit 211f. The regular monitoring unit 211a, monitoring status storage unit 211b, monitoring status control unit 211c, network interface 211d, and error log storage unit 211e function similarly to their respective counterparts in the console unit 100 discussed above. The reboot command unit 211f issues a reboot command to the internal server monitoring unit 212.

The internal server monitoring unit 212 includes a regular monitoring unit 212a, a monitoring status storage unit 212b, a monitoring status control unit 212c, a network interface 212d, an error log storage unit 212e, and a rebooting unit 212f. The regular monitoring unit 212a, monitoring status storage unit 212b, monitoring status control unit 212c, network interface 212d, and error log storage unit 212e function similarly to their respective counterparts in the console unit 100 discussed above. The rebooting unit 212f makes the internal server monitoring unit 212 reboot itself in response to a reboot command from the management control unit 211.

It is noted that the lines interconnecting the functional blocks in FIG. 8 are only an example, and some communication paths may be omitted for simplicity purposes. The person skilled in the art would appreciate that there may be other communication paths in actual implementations. It is also noted that the console unit 100, management control unit 211, and internal server monitoring unit 212 may have various non-illustrated functions other than those used in the process of operation monitoring.

The regular monitoring units 110, 211a, and 212a seen in FIG. 8 are an exemplary implementation of the monitoring unit 1a and time measurement unit 1b previously discussed in FIG. 1 for the first embodiment. The monitoring status control units 130, 211c, and 212c are an exemplary implementation of the querying unit 1c and determination unit 1d discussed in FIG. 1 for the first embodiment. The network interfaces 140, 211d, and 212d are an exemplary implementation of the connection unit 1e discussed in FIG. 1 for the first embodiment. The error log storage units 150, 211e, and 212e are an exemplary implementation of the storage device 1f discussed in FIG. 1 for the first embodiment.

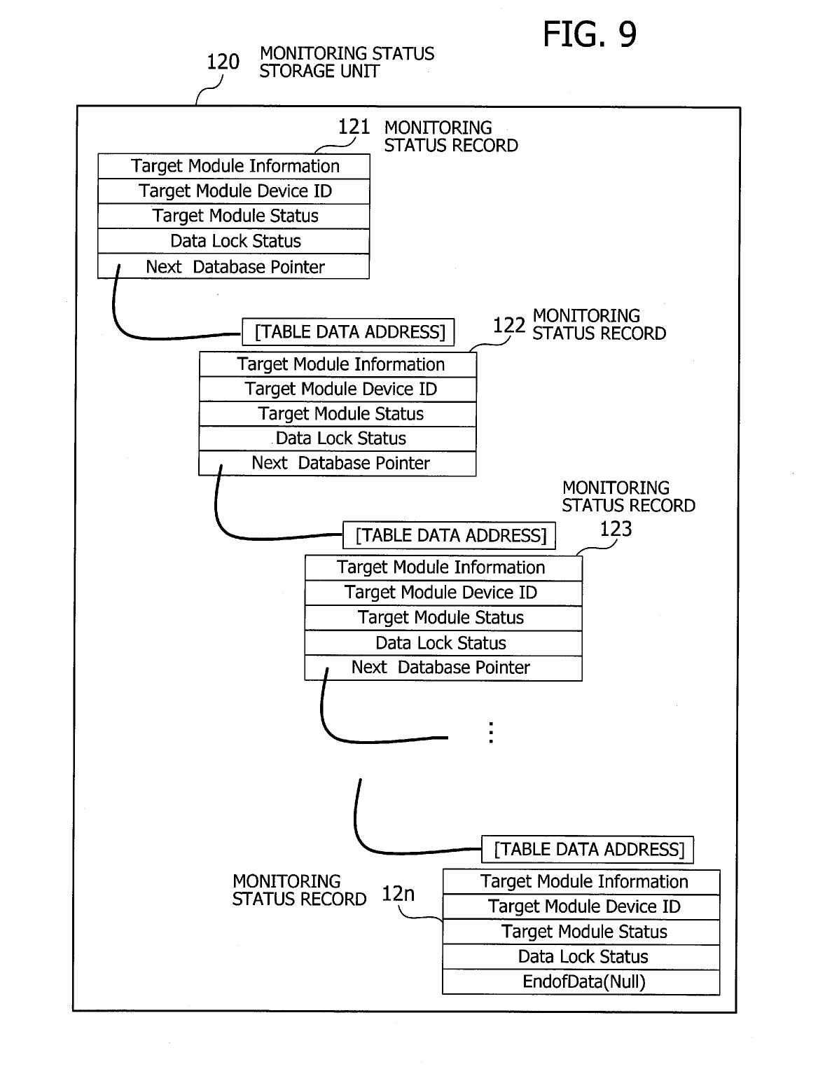

The monitoring status storage unit 120 has a data structure described below. FIG. 9 illustrates an exemplary data structure of the monitoring status storage unit 120. Specifically, the illustrated monitoring status storage unit 120 stores a plurality of monitoring status records 121, 122, 123, . . . , and 12n in the form of a data chain structure. Each of these monitoring status records 121, 122, 123, . . . , and 12n is formed as a set of data fields named “Target Module Information,” “Target Module Device ID,” “Target Module Status,” “Data Lock Status,” and “Next Database Pointer.” The target module information field contains an identifier (e.g., name) that indicates a specific target device installed in a module. The target module device ID field contains an identifier of the installed target device. The target module status field indicates monitoring status of the target device. The data lock status field indicates whether update of the data is allowed or inhibited. This data field is used for mutual exclusion in concurrent programs. That is, the regular monitoring unit 110 avoids contention of data access by changing the data lock status field. The next database pointer field points to the next monitoring status record in the data chain.

Just as the console unit 100 stores the above monitoring status records of FIG. 9 in its monitoring status storage unit 120, the management control unit 211 and internal server monitoring unit 212 also have monitoring status records in their respective monitoring status storage units 211b and 212b with a similar data structure. These monitoring status storage units 120, 211b, and 212b are controlled under a synchronization mechanism, so that they store the same data content.

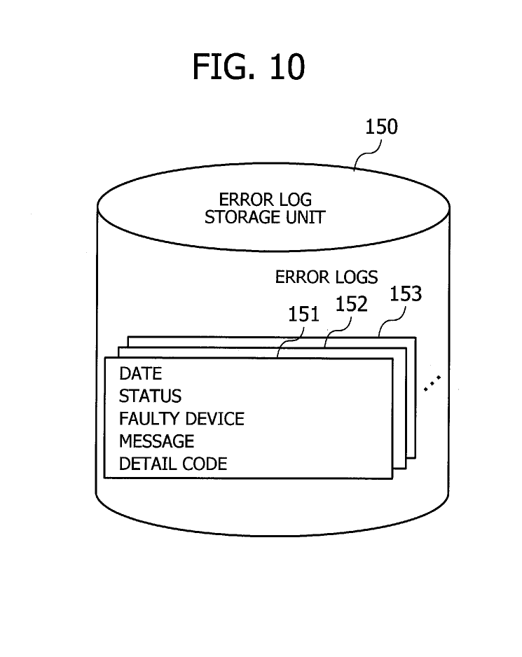

The error log storage unit 150, on the other hand, stores error logs with a data structure described below. FIG. 10 illustrates an exemplary data structure of the error log storage unit 150. The illustrated error log storage unit 150 stores a plurality of error logs 151, 152, 153, and so on. Each of these error logs 151, 152, 153, . . . is formed from the following data fields: “Date,” “Status,” “Faulty Device,” “Message,” and “Detail Code.” The date field indicates the date and time when the error log was recorded. The status field contains a value of “Error,” “Warning,” or the like to indicate what type of event it was. The faulty device field indicates which device or component is suspected to be the cause of the error. The message field contains a character string indicating the error type. The detail code field contains a piece of information that was collected in relation to the detected error for the purpose of troubleshooting.

More specifically, the information in the detail code field includes device type and device ID of the monitoring device, as well as those of the target device. The detail code field therefore suggests which pair of devices encountered the error in question.

The next section describes what information is exchanged between the devices. For example, the second embodiment uses high-level commands (HLC) for device-to-device communication. HLC defines a pair of frames for interaction of devices, i.e., an HLC command frame and its corresponding HLC command response frame.

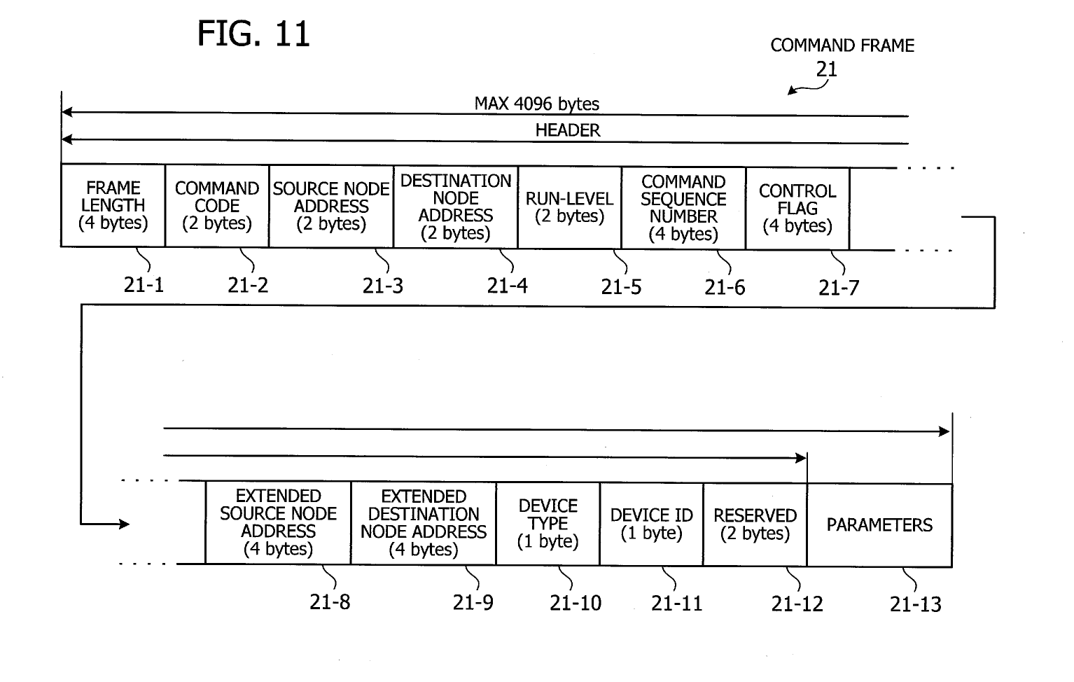

FIG. 11 illustrates the format of HLC command frames. The illustrated command frame 21 is formed from a plurality of data fields 21-1 to 21-13 with the following names: “Frame Length,” “Command Code,” “Source Node Address,” “Destination Node Address,” “Run-Level,” “Command Sequence Number,” “Control Flag,” “Extended Source Node Address,” “Extended Destination Node Address,” “Device Type,” “Device ID,” “Reserved”, and “Parameters.” The leading portion of this command frame 21 before the parameters field 21-13 is referred to as the header. The maximum size of a command frame 21 is limited to 4096 bytes.

The frame length field 21-1 contains a 4-byte value that indicates the entire length (including the header and parameters) of the command frame 21. The command code field 21-2 contains a 2-byte code (command code) of a high-level command. More specifically, bit #0 of the command code is referred to as the command/response bit. The binary value of this command/response bit indicates whether the frame is a command frame (“0”) or a response frame (“1”).

Bit #1 to bit #7 give a 7-bit binary value (0x00 to 0x7F) of class code that represents what type of high-level command it is. Bit #8 to bit #15 give an 8-bit binary value (0x00 to 0xFF) of function code that specifies what function of the high-level command is to execute. The combination of a particular class code and a particular function code describes what is intended by the high-level command. For example, the class code and function code may take a value of 0x4002. This code means that the command is for the purpose of health check (regular monitoring). Similarly, another code value 0x4003 represents a communication start command. Yet another code value 0x4004 represents a communication stop command. Still another code value 0x4010 represents a monitoring status request command for confirming whether a particular device is alive.

The source node address field 21-3 contains a 2-byte node address representing the sending device (source node) of this command frame. The destination node address field 21-4 contains a 2-byte node address representing the receiving device (destination node) of this command frame. The run-level field 21-5 contains a 2-byte value of the priority at which this command is to be taken out of the stack of pending high-level commands. The command sequence number field 21-6 contains a 4-byte sequence number of this command frame.

The control flag field 21-7 is a 4-byte field including a flag that indicates whether the extended node address is valid. The extended source node address field 21-8 contains a 4-byte extended node address of the source node of this command frame. The extended destination node address field 21-9 contains a 4-byte extended node address of the destination node of this command frame.

The device type field 21-10 contains a 1-byte data value that indicates, in the case of a monitoring status request, which type of device is under confirmation about its monitoring status. For example, the eight bits of this device type field are assigned as follows:

1) Console unit 100 (bit #0)

2) Management control unit 211 (bit #1)

3) Internal server monitoring unit 212 (bit #2)

4) Reserved (bit #3 to bit #7)

More specifically, one of these bits is set to one to indicate that its corresponding device is under confirmation.

The device ID field 21-11 contains a 1-byte device number indicating the device under confirmation specified in the device type field 21-10. The reserved field 21-12 is a 2-byte field reserved for future use. The parameters field 21-13 may contain a variety of parameters.

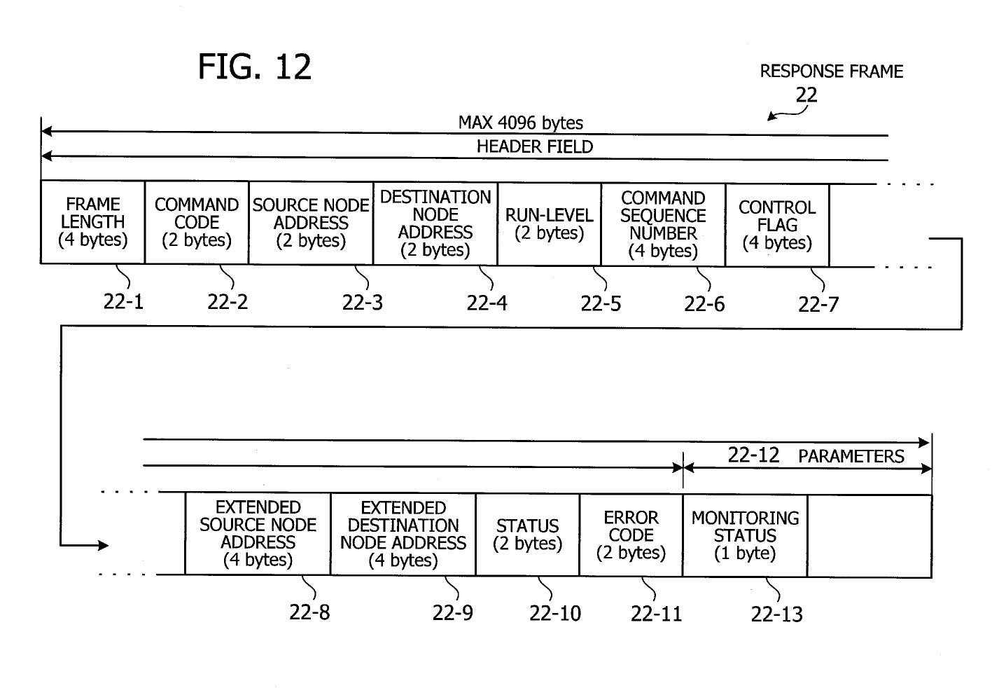

FIG. 12 illustrates the format of HLC response frames. This response frame 22 is formed from a plurality of data fields 22-1 to 22-12 with the following names: “Frame Length,” “Command Code,” “Source Node Address,” “Destination Node Address,” “Run-Level,” “Command Sequence Number,” “Control Flag,” “Expanded Source Node Address,” “Expanded Destination Node Address,” “Status,” “Error Code,” and “Parameters.” The first nine data fields 22-1 to 22-9, “Frame Length” to “Expanded Destination Node Address,” have the same meanings as their respective counterparts in the command frame 21 discussed above.

The status field 22-10 is a 2-byte data field indicating the result status of a high-level command that is executed. When the command is executed properly, the status field 22-10 returns zeros in all bits. When the command ends up with an error, its corresponding bit is set to one to indicate what error has occurred.

Specifically, the bit assignment of the status field 22-10 is as follows:

1) Undefined Command (Bit #0)

2) Parameter Error (Bit #1)

3) Execution Condition Error (Bit #2)

4) Run-time Error (Bit #3)

5) Reserved (Bit #4 to Bit #7)

The error code field 22-11 provides the details of an execution condition error or a run-time error when the status field 22-10 indicates such errors.

The parameters field 22-12 may contain various values, one of which is a monitoring status field 22-13 with a length of one byte. This monitoring status field 22-13 is a collection of bits each indicating a different state of the device under confirmation. Specifically, the bit assignment of the monitoring status field 22-13 is as follows:

1) Under Monitoring (Bit #0): The destination device of a monitoring status request is currently monitoring the device under confirmation.

2) Monitoring in Halt (Bit #1): The requested module temporarily stops monitoring the device under confirmation.

3) Response Received (Bit #2): The requested module is receiving responses from the device under confirmation in its regular monitoring.

4) Response Timeout (Bit #3): The requested device has detected a timeout of response from the device under confirmation.

5) Reserved (Bit #4 to Bit #7)

The devices communicate with each other and monitor the operation of each other by using such HLC frames. The next section describes specific procedures of operation monitoring performed by the console unit 100, management control unit 211, and internal server monitoring unit 212. It is assumed that the internal server monitoring unit 212 is rebooted according to a command from the management control unit 211.

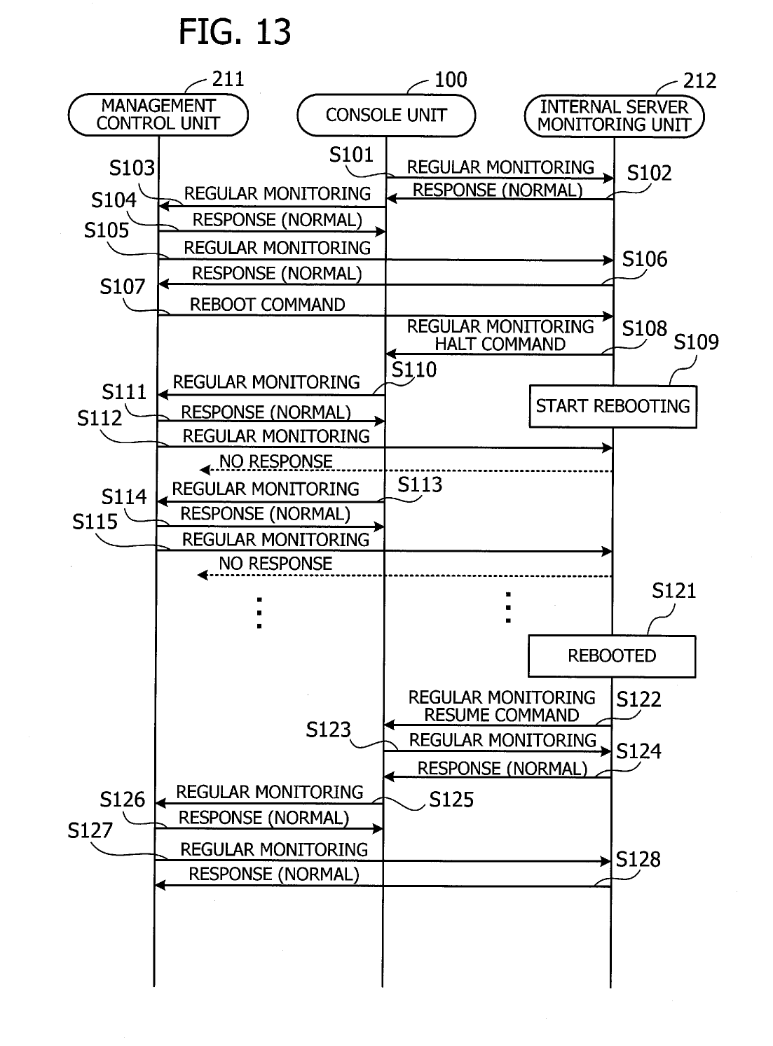

FIG. 13 is a sequence diagram illustrating a first exemplary procedure of operation monitoring. This is an example in which all devices are working properly and able to communicate with one another. The operation seen in FIG. 13 is described below in the order of step numbers.

(Step S101) The regular monitoring unit 110 in the console unit 100 performs regular monitoring of the internal server monitoring unit 212. For example, the regular monitoring unit 110 sends the internal server monitoring unit 212 an HLC command for regular monitoring.

The HLC command from the console unit 100 is received by the internal server monitoring unit 212, which permits its regular monitoring unit 212a to recognize that the console unit 100 is operating properly. If this response means a change in the status of the console unit 100, the regular monitoring unit 212a updates the status value of its corresponding monitoring status record in the monitoring status storage unit 212b.

(Step S102) The regular monitoring unit 212a in the internal server monitoring unit 212 returns a normal response to the above HLC command from the console unit 100. More specifically, this normal response is in the form of a response frame 22 whose status field 22-10 is set to zeros.

In the console unit 100, the regular monitoring unit 110 receives the above normal response from the internal server monitoring unit 212. If this response means a change in the status of the internal server monitoring unit 212, the regular monitoring unit 110 updates the status value of its corresponding monitoring status record in the monitoring status storage unit 120.

(Step S103) The regular monitoring unit 110 in the console unit 100 performs regular monitoring of the management control unit 211. For example, the regular monitoring unit 110 sends the management control unit 211 an HLC command for regular monitoring.

The HLC command from the console unit 100 is received by the management control unit 211, which permits its regular monitoring unit 211a to recognize that the console unit 100 is operating properly. If this response means a change in the status of the console unit 100, the management control unit 211 updates the status value of its corresponding monitoring status record in the monitoring status storage unit 211b.

(Step S104) The regular monitoring unit 211a in the management control unit 211 returns a normal response to the above HLC command from the console unit 100. If this response means a change in the status of the management control unit 211, the regular monitoring unit 110 updates the status value of its corresponding monitoring status record in the monitoring status storage unit 120.

(Step S105) The regular monitoring unit 211a in the management control unit 211 performs regular monitoring of the internal server monitoring unit 212. For example, the regular monitoring unit 211a sends the internal server monitoring unit 212 an HLC command for regular monitoring.

The HLC command from the management control unit 211 is received by the internal server monitoring unit 212, which permits its regular monitoring unit 212a to recognize that the management control unit 211 is operating properly. If this response means a change in the status of the management control unit 211, the regular monitoring unit 212a updates the status value of its corresponding monitoring status record in the monitoring status storage unit 212b.

(Step S106) The regular monitoring unit 212a in the internal server monitoring unit 212 returns a normal response to the above HLC command from the management control unit 211. If this response means a change in the status of the internal server monitoring unit 212, the regular monitoring unit 211a updates the status value of its corresponding monitoring status record in the monitoring status storage unit 211b.

As can be seen from the above, the console unit 100, management control unit 211, and internal server monitoring unit 212 are configured to watch each other's operation by repeating steps S101 to S106 at regular intervals.

It is now assumed that the internal server monitoring unit 212 reboots itself in order to, for example, synchronize its internal clock with the reference clock in an NTP server. More specifically, the administrator issues a reboot command to the internal server monitoring unit 212 through the console unit 100. This reboot command is passed to the management control unit 211. Then, under the control of the management control unit 211, the internal server monitoring unit 212 executes rebooting as follows.

(Step S107) The reboot command unit 211f in the management control unit 211 sends a reboot command to the internal server monitoring unit 212. The reboot command unit 211f also notifies this local regular monitoring unit 211a that the internal server monitoring unit 212 is to be rebooted. With this notification, the regular monitoring unit 211a does not care about the internal server monitoring unit 212 for a certain time period that follows. That is, the regular monitoring unit 211a does not detect errors even if there is no response from the internal server monitoring unit 212.

(Step S108) In the internal server monitoring unit 212, the rebooting unit 212f receives the above reboot command from the management control unit 211. The rebooting unit 212f then gives a prior notice of rebooting to the regular monitoring unit 212a. In response, the regular monitoring unit 212a sends a regular monitoring halt command to the console unit 100.

(Step S109) Upon confirmation that the regular monitoring halt command has been transmitted, the rebooting unit 212f initiates rebooting of the internal server monitoring unit 212. All the functions in the internal server monitoring unit 212 are once stopped, and restarted after initialization of data in the memory and the like.

(Step S110) In response to the regular monitoring halt command from the internal server monitoring unit 212, the regular monitoring unit 110 in the console unit 100 stops regular monitoring of the internal server monitoring unit 212. The regular monitoring unit 110 records this change by updating a monitoring status record stored in the monitoring status storage unit 120 for the internal server monitoring unit 212 with a new status value of “Monitoring in Halt.” This update made to the monitoring status storage unit 120 further propagates to other monitoring status storage units 211b and 212b through the foregoing synchronization processing among the regular monitoring units 110, 211a, and 212a.

The regular monitoring unit 110, on the other hand, continues regular monitoring of the management control unit 211 by sending an HLC command to the management control unit 211.

(Step S111) The regular monitoring unit 211a in the management control unit 211 returns a normal response to the above HLC command from the console unit 100.

(Step S112) The regular monitoring unit 211a in the management control unit 211 performs regular monitoring of the internal server monitoring unit 212. For example, the regular monitoring unit 211a sends the internal server monitoring unit 212 an HLC command for regular monitoring. The internal server monitoring unit 212, however, does not respond to this HLC command because it is right in the middle of rebooting.

The subsequent steps S113 to S115 are similar to steps S110 to S112 described above. These steps are repeated at regular intervals.

(Step S121) The rebooting of the internal server monitoring unit 212 is finished. The network interface 212d thus sets up a network connection again with the console unit 100, so that they can resume communication over the network. The network interface 212d also sets up a network connection with the management control unit 211, thus making it possible for the internal server monitoring unit 212 to exchange HLC and other messages with both the console unit 100 and management control unit 211.

(Step S122) Upon rebooting, the regular monitoring unit 212a sends a regular monitoring resume command to the console unit 100. In response, the regular monitoring unit 110 in the console unit 100 resumes regular monitoring of the internal server monitoring unit 212.

Since regular monitoring of the internal server monitoring unit 212 is resumed, the regular monitoring unit 110 changes its corresponding monitoring status record in the monitoring status storage unit 120, from “Monitoring in Halt” to “Under Monitoring.” This update made to the monitoring status storage unit 120 further propagates to other monitoring status storage units 211b and 212b through the synchronization processing among the regular monitoring units 110, 211a, and 212a.

The subsequent steps S123 to S128 are similar to steps S101 to S106 described above. These steps are repeated at regular intervals.

As can be seen from the above-described procedure of regular monitoring, rebooting of the internal server monitoring unit 212 does not invite errors, as long as each device is operating properly, because of the regular monitoring halt commands and other measures.

The next section describes another exemplary procedure of operation monitoring, in which the internal server monitoring unit 212 is rebooted correctly, but it fails to set up a network connection.

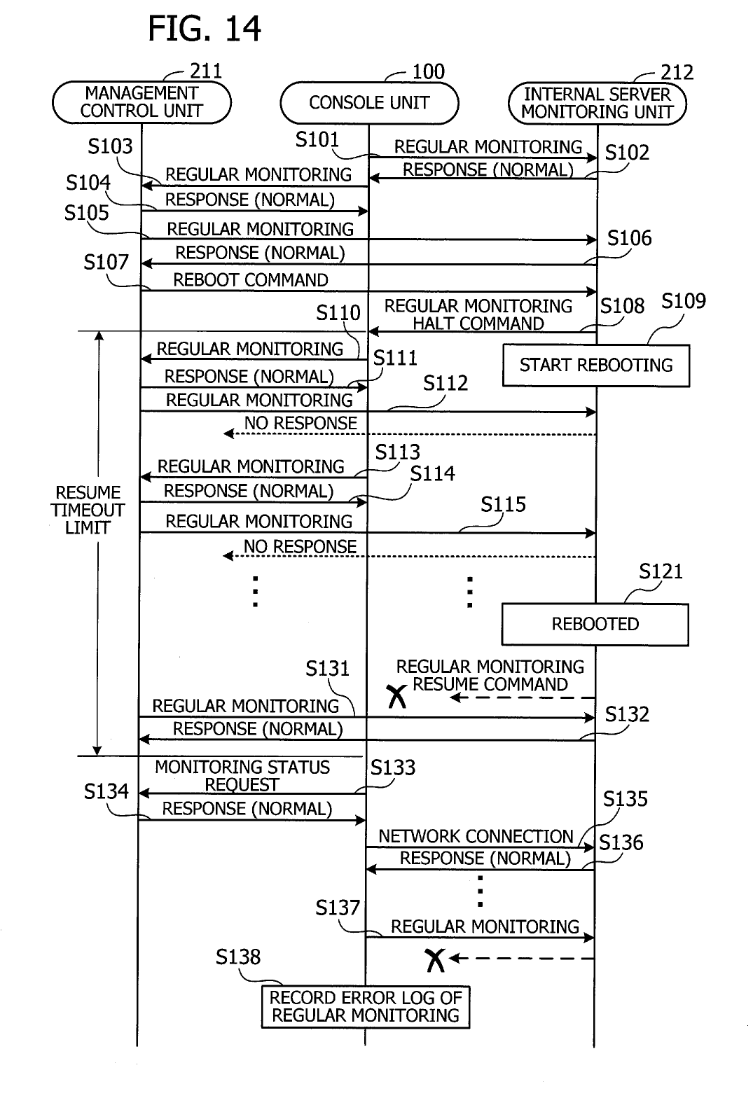

FIG. 14 is a sequence diagram illustrating a second exemplary procedure of operation monitoring. This is an example in which the rebooted internal server monitoring unit 212 is unable to set up a network connection with the console unit 100.

More specifically, the internal server monitoring unit 212 has successfully finished its own rebooting but fails to set up a network connection with the console unit 100. For this reason, the console unit 100 does not receive a regular monitoring resume command which is supposed to be sent from the internal server monitoring unit 212 to the console unit 100. It is assumed, on the other hand, that the internal server monitoring unit 212 is successful in setting up a network connection with the management control unit 211 after the rebooting.

The procedure of FIG. 14 includes several steps similar to those described in FIG. 13. FIGS. 13 and 14 thus share the same step numbers for such similar steps. See the previous description of FIG. 13 for details of those steps. The distinct steps in FIG. 14 will now be described below in the order of step numbers.

(Step S131) The regular monitoring unit 211a in the management control unit 211 performs regular monitoring of the internal server monitoring unit 212 by sending it an HLC command for regular monitoring.

(Step S132) The regular monitoring unit 212a in the internal server monitoring unit 212 returns a normal response to the above HLC command from the management control unit 211. Upon receipt of this normal response from the internal server monitoring unit 212, the regular monitoring unit 211a updates its corresponding monitoring status record in the monitoring status storage unit 211b by changing the status value to “Response Received.”

(Step S133) There have been no regular monitoring resume commands since the previous reception of a regular monitoring halt command at step S108. The regular monitoring unit 110 in the console unit 100 now detects expiration of a predetermined resume timeout limit. For example, this resume timeout limit may be a little longer than the expected time duration for the internal server monitoring unit 212 to complete its rebooting. The expiration of the resume timeout limit causes the regular monitoring unit 110 to notify the monitoring status control unit 130 that a timeout occurred while waiting a regular monitoring resume command. With this timeout notice, the monitoring status control unit 130 sends a monitoring status request to the management control unit 211, specifying the internal server monitoring unit 212 as a device under confirmation.

(Step S134) The above monitoring status request is received by the monitoring status control unit 211c in the management control unit 211. The monitoring status control unit 211c searches the monitoring status storage unit 211b to retrieve a monitoring status record corresponding to the internal server monitoring unit 212. The retrieved record contains status information of the internal server monitoring unit 212. The monitoring status control unit 211c then sends a normal response back to the console unit 100, which conveys the requested status information in its monitoring status field.

(Step S135) The above normal response from the management control unit 211 is received by the monitoring status control unit 130 in the console unit 100. Based on the monitoring status field of the response, the monitoring status control unit 130 recognizes that the internal server monitoring unit 212 is operating properly. The monitoring status control unit 130 now makes an assumption that the lack of regular monitoring resume commands is due to a network fault. Accordingly, the monitoring status control unit 130 requests the network interface 140 to attempt a network connection with the internal server monitoring unit 212. In response to this request, the network interface 140 attempts to make a network connection with the internal server monitoring unit 212. This attempt succeeds in the example of FIG. 14.

(Step S136) The network interface 212d in the internal server monitoring unit 212 returns a normal response to the console unit 100 to indicate that it has made a network connection without problems. In the console unit 100, the successful network connection is reported from the network interface 140 to the monitoring status control unit 130. The monitoring status control unit 130 therefore withdraws its previous assumption of network fault and informs the regular monitoring unit 110 that the internal server monitoring unit 212 is ready for communication.

The regular monitoring unit 110 thus restarts regular monitoring of the internal server monitoring unit 212. At the beginning, the regular monitoring unit 110 changes the status value of a monitoring status record corresponding to the internal server monitoring unit 212 back to “Under Monitoring.” The same record in the monitoring status storage unit 120 will further be changed to “Response Received” when a response to the regular monitoring is received from the internal server monitoring unit 212.

As can be seen from the above example, even when the internal server monitoring unit 212 fails to make a network connection with the console unit 100, it does not always mean that the network is also impaired in the other way around. Rather, the console unit 100 may be able to set up a network connection to the internal server monitoring unit 212. Suppose, for example, that the network is heavily loaded with multiple access and the like. The network could temporarily be unable to accept connections, causing the regular monitoring unit 110 to detect a timeout of regular monitoring resume commands. In this situation, the troubleshooting would take more time and work unless the problem is properly isolated, i.e., whether it is due to a fundamental fault in the network or a temporary increase of network load.

In the case of a temporary network disruption, it may be possible to solve the situation by changing some conditions for a network connection. The above-described second embodiment is configured to change the source node of a network connection. That is, if one device fails to set up a network connection, then the opposite device tries to do the same. As a result of this control, the frequency of network error notices is reduced in the case where the network is heavily loaded, thus alleviating the need for time and work of troubleshooting.

The process of regular monitoring may, of course, encounter a real disruption of response from the internal server monitoring unit 212. When this is the case, the following steps are executed.

(Step S137) The regular monitoring unit 110 performs regular monitoring of the internal server monitoring unit 212 by sending it an HLC command for regular monitoring.

(Step S138) There is no response from the internal server monitoring unit 212, and the regular monitoring ends up with expiration of a response timeout limit. This timeout event causes the regular monitoring unit 110 to add an error log of regular monitoring error in the error log storage unit 150. The regular monitoring unit 110 also updates a monitoring status record that the monitoring status storage unit 120 stores for the internal server monitoring unit 212, by changing its status value to “Monitoring Timeout.”

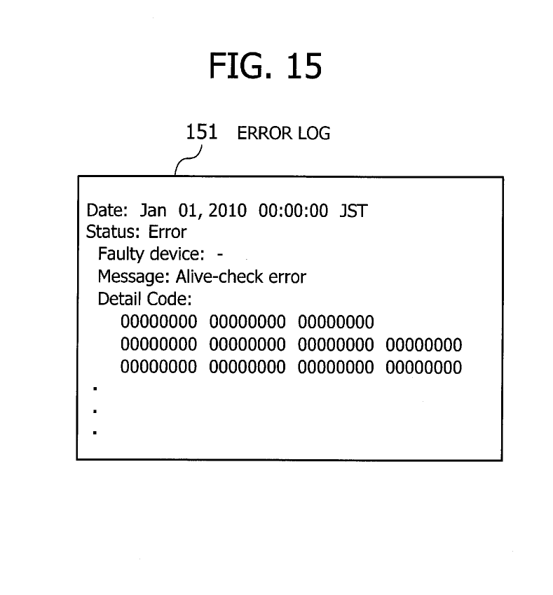

FIG. 15 illustrates an exemplary error log produced in the case of a timeout during regular monitoring. The illustrated error log 151 includes a status value of “Error” and a message “Alive-check error” indicating a failure found in the regular monitoring.

The next section describes yet another procedure of operation monitoring, in which the internal server monitoring unit 212 is rebooted correctly, but both the internal server monitoring unit 212 and console unit 100 fail to set up a network connection.

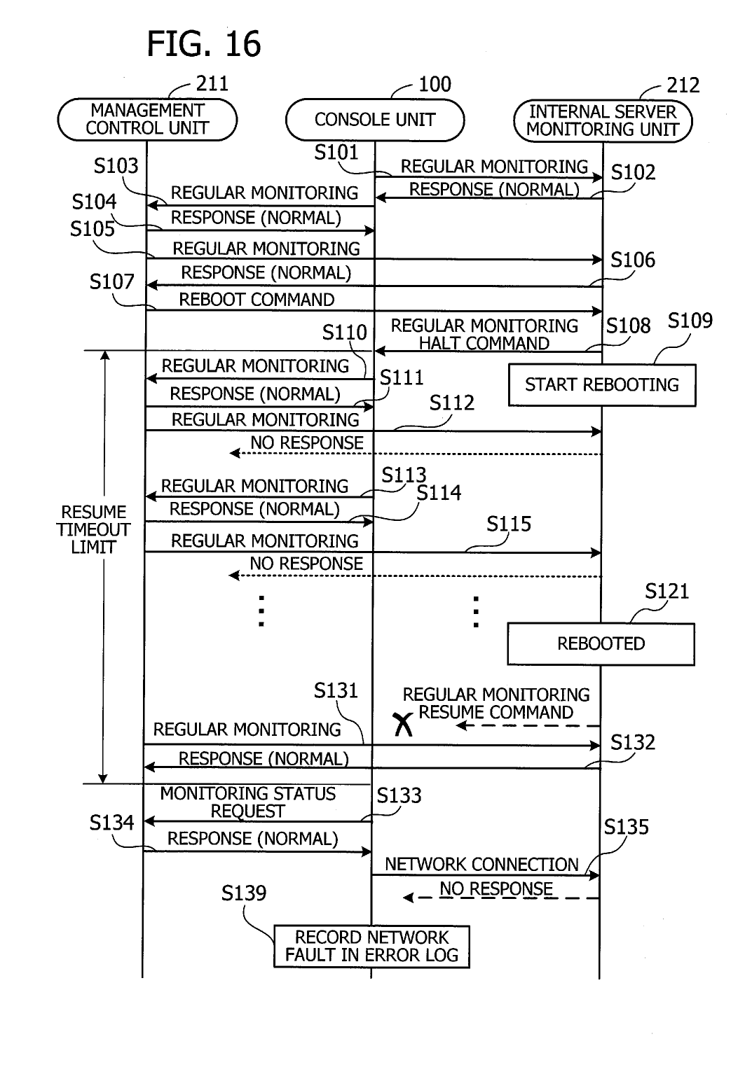

FIG. 16 is a sequence diagram illustrating a third exemplary procedure of operation monitoring. This procedure is an example in which the rebooted internal server monitoring unit 212 is unable to set up a network connection with the console unit 100, and the console unit 100 is also unable to set up a network connection with the internal server monitoring unit 212.

Most steps in the procedure of FIG. 16 are similar to those described in FIG. 14. Actually, step S139 described below is the only step in FIG. 16 that is not seen in the procedure of FIG. 14. See the previous description of FIG. 14 for details of the other steps of

FIG. 16, which have the same step numbers as their counterparts in FIG. 14.

(Step S139) The internal server monitoring unit 212 does not respond to the attempt by the console unit 100 to set up a network connection with the internal server monitoring unit 212. The network interface 140 then notifies the monitoring status control unit 130 of the failed attempt of connection. The monitoring status control unit 130 concludes that a network fault is present, and thus adds an error long in the error log storage unit 150 to record the event. More specifically, the monitoring status information obtained from the management control unit 211 indicates that the internal server monitoring unit 212 is operating properly. This fact makes the monitoring status control unit 130 determine that the unsuccessful network connection is caused by a fault in the network itself. The monitoring status control unit 130 adds an error log in the internal server monitoring unit 212 to record the network fault.

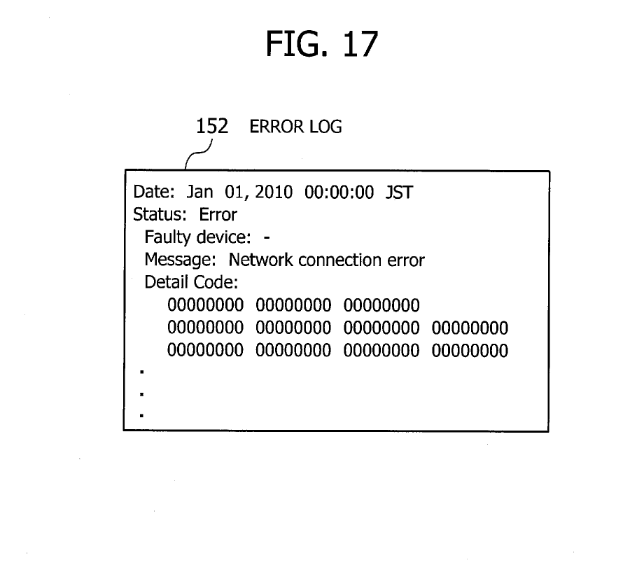

FIG. 17 illustrates an exemplary error log produced in the case of network reconnection failure. The illustrated error log 152 includes a status value of “Error” and a message “Network connection error” indicating an unsuccessful network connection.

The next section describes still another procedure of operation monitoring, in which the internal server monitoring unit 212 fails to reboot itself properly.

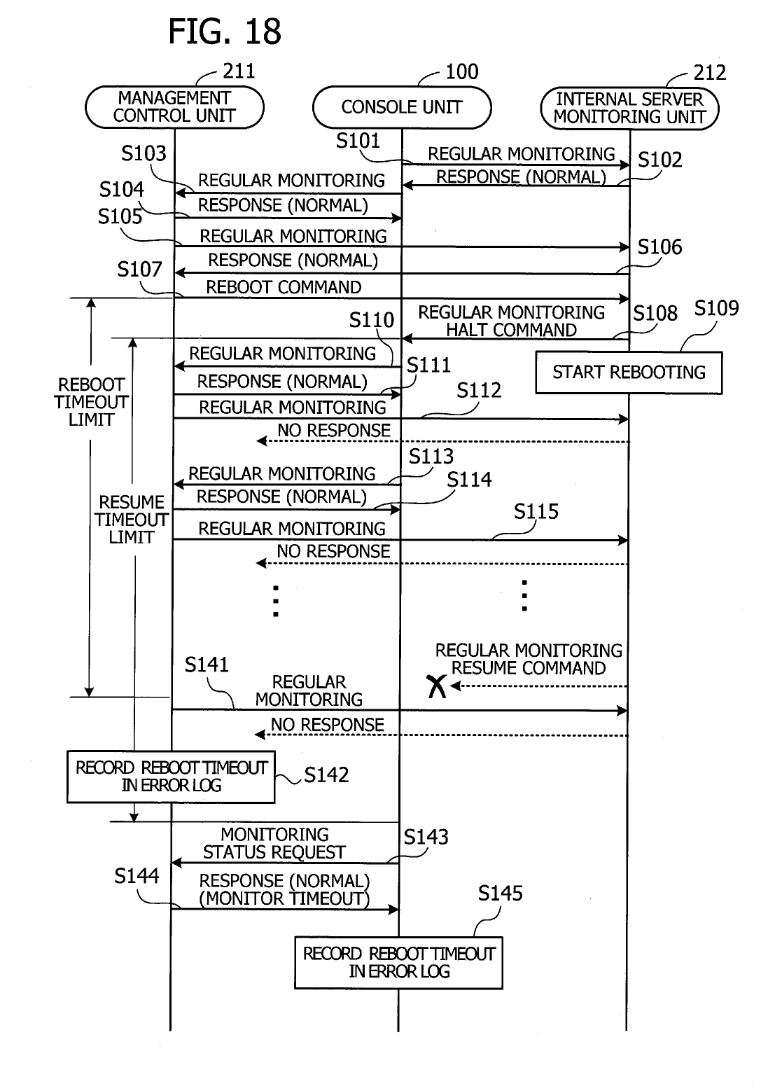

FIG. 18 is a sequence diagram illustrating a fourth exemplary procedure of operation monitoring. This is an example in which the internal server monitoring unit 212 fails in its rebooting process. FIG. 18 shares the same step numbers with FIG. 14 for similar steps in their procedures. See the previous description of FIG. 14 for details of such steps. The following steps S141 to S145, on the other hand, are only in the procedure of FIG. 18.

(Step S141) Upon expiration of a reboot timeout limit since the previous reboot command to the internal server monitoring unit 212, the regular monitoring unit 211a in the management control unit 211 starts regular monitoring. The internal server monitoring unit 212, however, is unable to respond to the regular monitoring unit 211a because of its failed rebooting. The lack of response results in a timeout of regular monitoring.

(Step S142) Because of the timeout of regular monitoring after the reboot timeout limit, the regular monitoring unit 211a adds an error log in the error log storage unit 211e to record the reboot timeout. The regular monitoring unit 211a also updates a monitoring status record that the monitoring status storage unit 211b stores for the internal server monitoring unit 212 by changing its status value to “Monitoring Timeout”.

(Step S143) With no regular monitoring resume command received, the regular monitoring unit 110 in the console unit 100 detects expiration of a predetermined resume timeout limit since the previous reception of a regular monitoring halt command. The regular monitoring unit 110 thus notifies the monitoring status control unit 130 that a timeout occurred while waiting a regular monitoring resume command. With this timeout notice, the monitoring status control unit 130 sends the management control unit 211a monitoring status request that specifies the internal server monitoring unit 212 as a device under confirmation.

(Step S144) The above monitoring status request is received by the monitoring status control unit 211c in the management control unit 211. The monitoring status control unit 211c then consults the monitoring status storage unit 211b to retrieve a monitoring status record of the internal server monitoring unit 212. The monitoring status control unit 211c returns a normal response to the console unit 100, including the status value seen in the retrieved monitoring status record. More specifically, this normal response contains monitoring status information indicating “Monitoring Timeout.”

(Step S145) Based on the monitoring status information in the received normal response, the monitoring status control unit 130 in the console unit 100 recognizes that the internal server monitoring unit 212 is not operating properly. Accordingly, the monitoring status control unit 130 adds an error long in the error log storage unit 150 to record the reboot timeout.

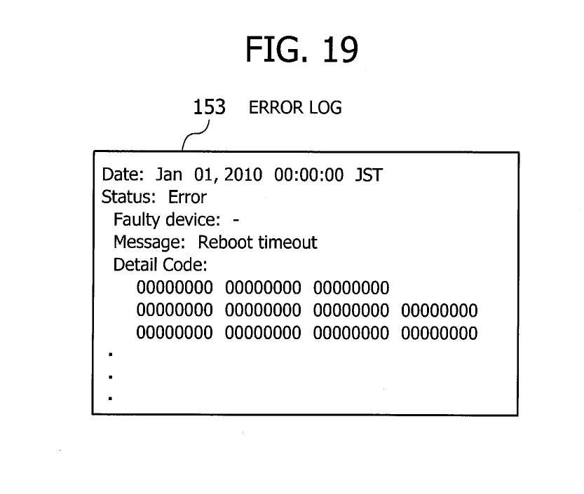

FIG. 19 illustrates an exemplary error log produced in the case of reboot failure. The illustrated error log 153 includes a status value of “Error” and a message “Reboot Timeout” indicating failed rebooting.

The next section describes still another procedure of operation monitoring in the case where no monitoring status information is obtained.

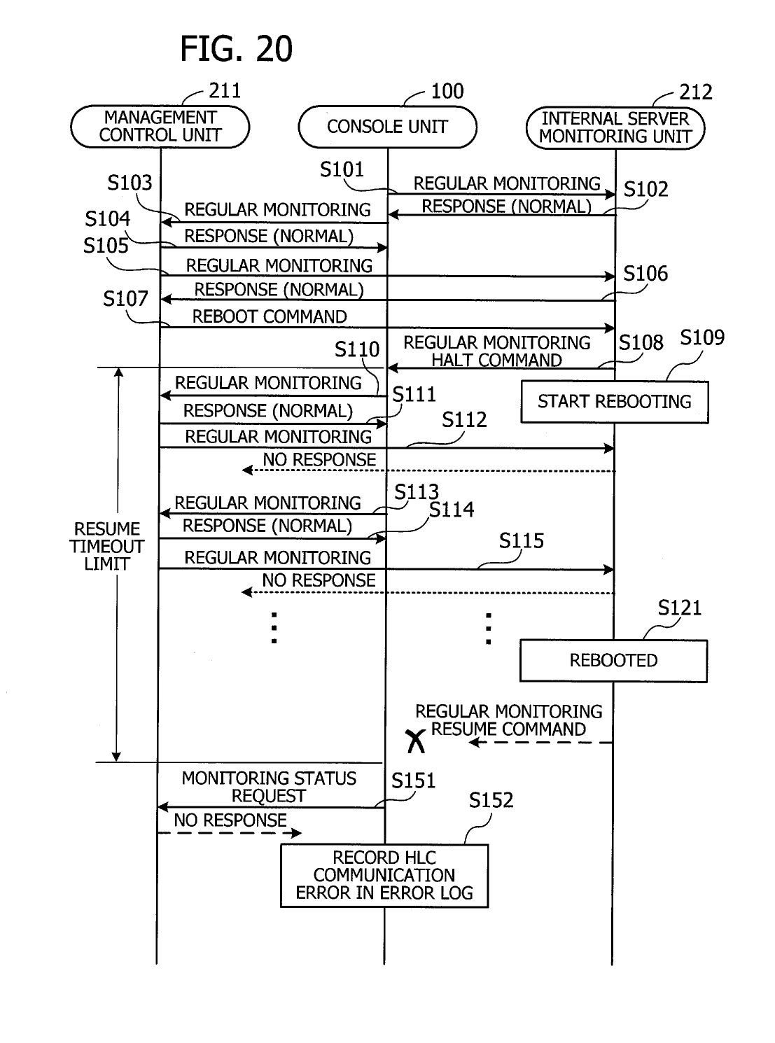

FIG. 20 is a sequence diagram illustrating a fifth exemplary procedure of operation monitoring. This is an example in which the console unit 100 fails to obtain monitoring status information. FIG. 20 shares the same step numbers with FIG. 14 for similar steps in the procedures. See the previous description of FIG. 14 for details of such steps. The following steps S151 and 152, on the other hand, are only in the procedure of FIG. 20.

(Step S151) Because no regular monitoring resume command is received, the regular monitoring unit 110 in the console unit 100 detects expiration of a predetermined resume timeout limit since the previous reception of a regular monitoring halt command. The regular monitoring unit 110 thus notifies the monitoring status control unit 130 of the expiration of the resume timeout limit. Upon receipt of this notice, the monitoring status control unit 130 sends the management control unit 211a monitoring status request that specifies the internal server monitoring unit 212 as a device under confirmation. The internal server monitoring unit 212, however, does not respond to this monitoring status request.

(Step S152) The regular monitoring unit 110 makes sure that the response timeout limit has been reached for the monitoring status request, thus adding an error log in the error log storage unit 150 to record the HLC communication error.

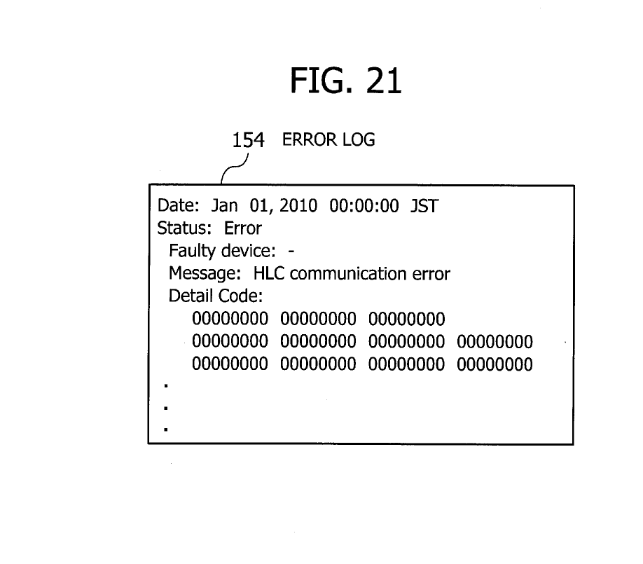

FIG. 21 illustrates an exemplary error log produced in the case of an HLC communication error. The illustrated error log 154 includes a status value of “Error” and a message “HLC communication error” indicating unsuccessful HLC communication.

Error logs are produced in this way as a result of absence of regular monitoring resume commands within a resume timeout limit. As can be seen from the above examples, the content of those error logs may vary depending on whether a monitoring status record can be obtained, as well as on what status is indicated in the obtained monitoring status record. The next section describes how each participating device operates during the process of regular monitoring and consequent output of error logs.

Regular monitoring may be implemented as an active process (e.g., polling) or a passive process (e.g., heartbeat check). In an active regular monitoring process, the monitoring device sends a regular monitoring command to the target device and anticipates a response indicating that the target device is alive. A passive regular monitoring, on the other hand, relies on regular monitoring commands sent from the target device to determine whether it is alive. In the example discussed in FIG. 13, the console unit 100 is actively monitoring both the management control unit 211 and internal server monitoring unit 212. The management control unit 211 is actively monitoring the internal server monitoring unit 212, while passively monitoring the console unit 100. The internal server monitoring unit 212 is passively monitoring both the console unit 100 and management control unit 211.

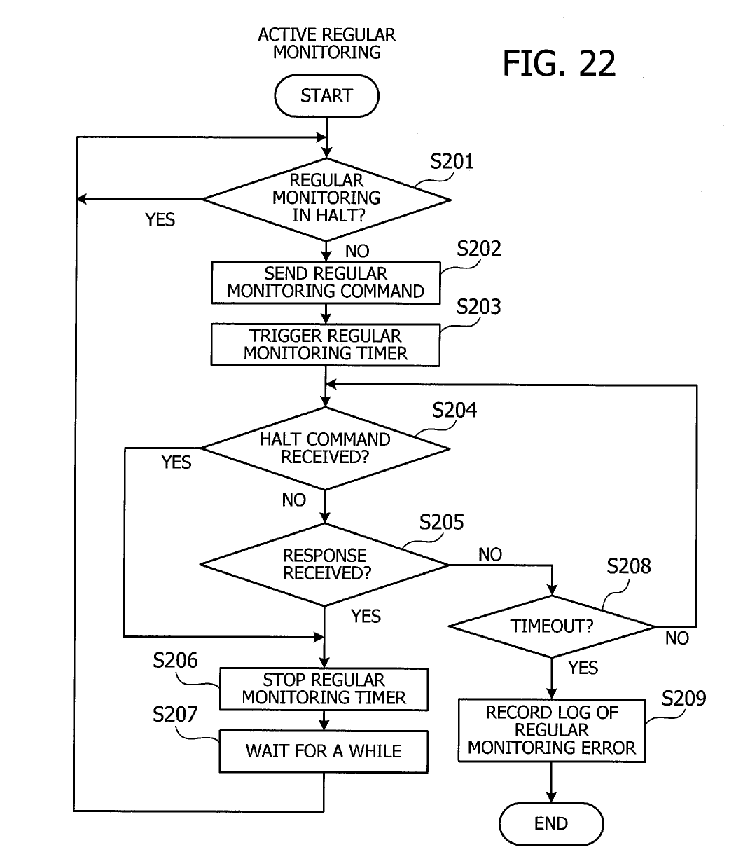

Active regular monitoring and passive regular monitoring will now be described individually. FIG. 22 is a flowchart illustrating a procedure of active regular monitoring. The operation seen in FIG. 22 is described below in the order of step numbers, assuming that the internal server monitoring unit 212 is a target device of active regular monitoring by the console unit 100.

(Step S201) The regular monitoring unit 110 determines whether the regular monitoring of the internal server monitoring unit 212 is in a halt state. For example, the regular monitoring unit 110 consults a relevant monitoring status record in the monitoring status storage unit 120 to test the status of the internal server monitoring unit 212. If the record indicates a “Monitoring in Halt” state, then the regular monitoring unit 110 determines that the regular monitoring is temporarily stopped, and thus it repeats the same step S201. If not, the regular monitoring unit 110 advances to step S202.

(Step S202) The regular monitoring unit 110 sends the internal server monitoring unit 212 an HLC command for regular monitoring.

(Step S203) The regular monitoring unit 110 triggers a regular monitoring timer to start time measurement.

(Step S204) The regular monitoring unit 110 determines whether a regular monitoring halt command is received from the internal server monitoring unit 212. If a regular monitoring halt command is received, the regular monitoring unit 110 skips to step S206. If not, the regular monitoring unit 110 proceeds to step S205.

(Step S205) The regular monitoring unit 110 determines whether a response to the above HLC command is received. If a response is received, the regular monitoring unit 110 advances to step S206. If not, the regular monitoring unit 110 proceeds to step S208.

(Step S206) The regular monitoring unit 110 stops and resets the regular monitoring timer to zero.

(Step S207) The regular monitoring unit 110 waits for a fixed time and then returns to step S201.

(Step S208) Since no response is received, the regular monitoring unit 110 determines whether the response timeout limit of regular monitoring has expired. For example, the regular monitoring unit 110 detects a timeout of regular monitoring when the regular monitoring timer reaches the response timeout limit. When a timeout is detected, the regular monitoring unit 110 advances to step S209. When the response timeout limit has not yet been reached, the regular monitoring unit 110 returns to step S204.

(Step S209) As the regular monitoring has ended up with a timeout, the regular monitoring unit 110 adds an error log in the error log storage unit 150 to record the regular monitoring error. The illustrated process is then terminated.

Passive regular monitoring will now be described below. According to the second embodiment, regular monitoring commands issued from a target device are interpreted as its heartbeat.

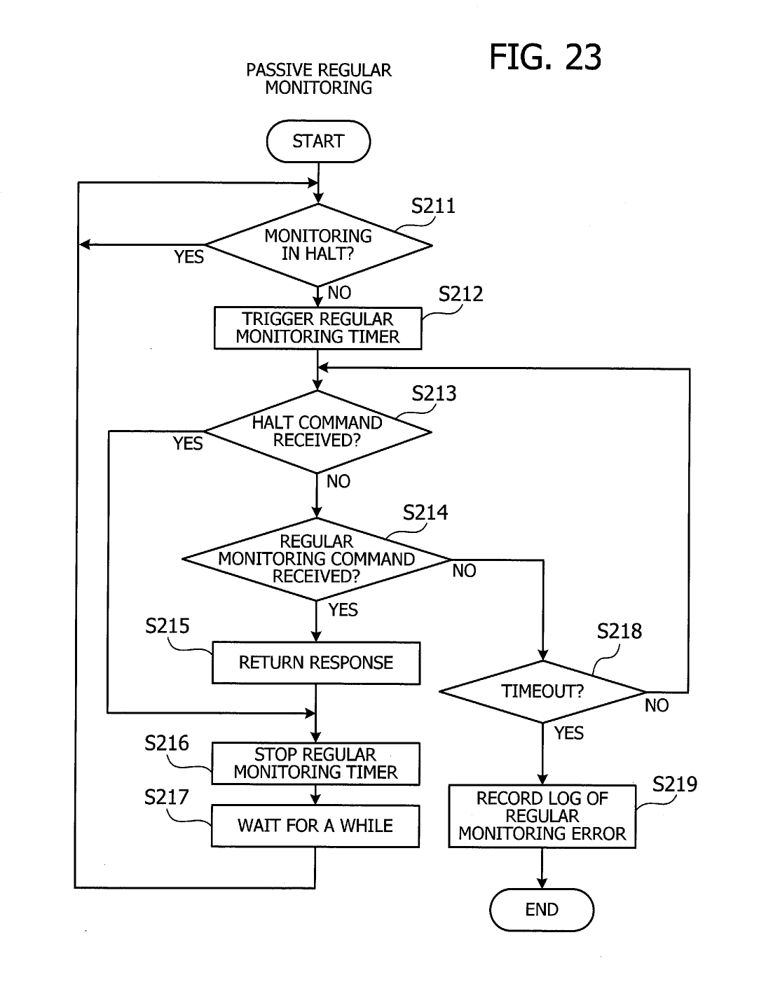

FIG. 23 is a flowchart illustrating a procedure of passive regular monitoring. The operation seen in FIG. 23 is described below in the order of step numbers, assuming that the console unit 100 is a target device of passive regular monitoring by the management control unit 211.

(Step S211) The regular monitoring unit 211a determines whether the regular monitoring of the console unit 100 is in a halt state. For example, the regular monitoring unit 211a consults a relevant monitoring status record in the monitoring status storage unit 211b to test the status of the console unit 100. If the record indicates a “Monitoring in Halt” state, then the regular monitoring unit 211a determines that the regular monitoring is temporarily stopped, and thus it repeats the same step S211. If not, the regular monitoring unit 211a advances to step S212.

(Step S212) The regular monitoring unit 211a triggers a regular monitoring timer to start time measurement.

(Step S213) The regular monitoring unit 211a determines whether a regular monitoring halt command is received from the console unit 100. If a regular monitoring halt command is received, the regular monitoring unit 211a skips to step S216. If not, the regular monitoring unit 211a proceeds to step S214.

(Step S214) The regular monitoring unit 211a determines whether an HLC command of regular monitoring is received. If such an HLC command is received, the regular monitoring unit 211a advances to step S215. If not, the regular monitoring unit 211a proceeds to step S218.

(Step S215) The regular monitoring unit 211a returns a response to the console unit 100.

(Step S216) The regular monitoring unit 211a stops and resets the regular monitoring timer to zero.

(Step S217) The regular monitoring unit 211a waits for a fixed time and then returns to step S211.

(Step S218) Since no HLC command is received, the regular monitoring unit 211a determines whether a response timeout limit of regular monitoring has expired. For example, the regular monitoring unit 211a detects a timeout of regular monitoring when the regular monitoring timer reaches the response timeout limit. When a timeout is detected, the regular monitoring unit 211a advances to step S219. When the response timeout limit has not yet been reached, the regular monitoring unit 211a returns to step S213.

(Step S219) As the regular monitoring has ended up with a timeout, the regular monitoring unit 211a adds an error log in the error log storage unit 211e to record the regular monitoring error. The illustrated process is then terminated.

As seen from FIGS. 22 and 23, two devices perform regular monitoring of each other, one using an active method and the other using a passive method. This combined use of active and passive monitoring methods reduces the amount of network traffic associated with the mutual regular monitoring.

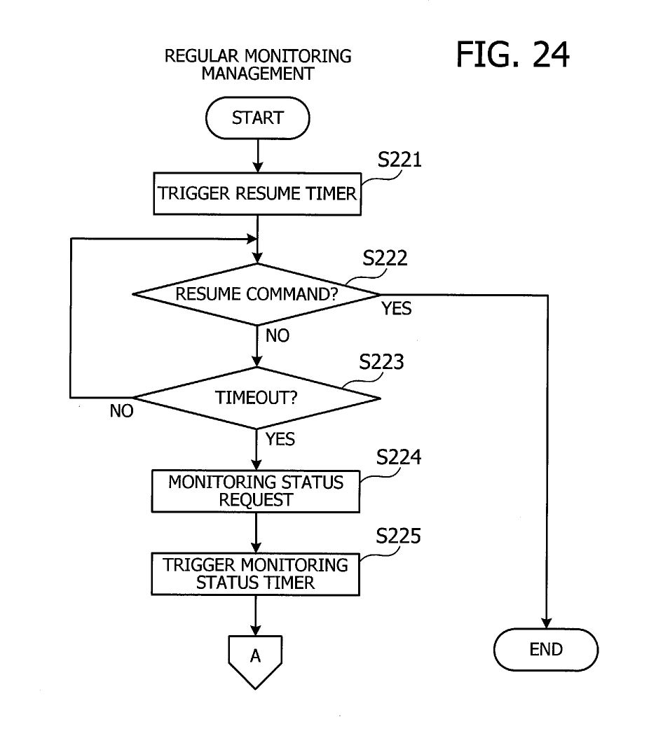

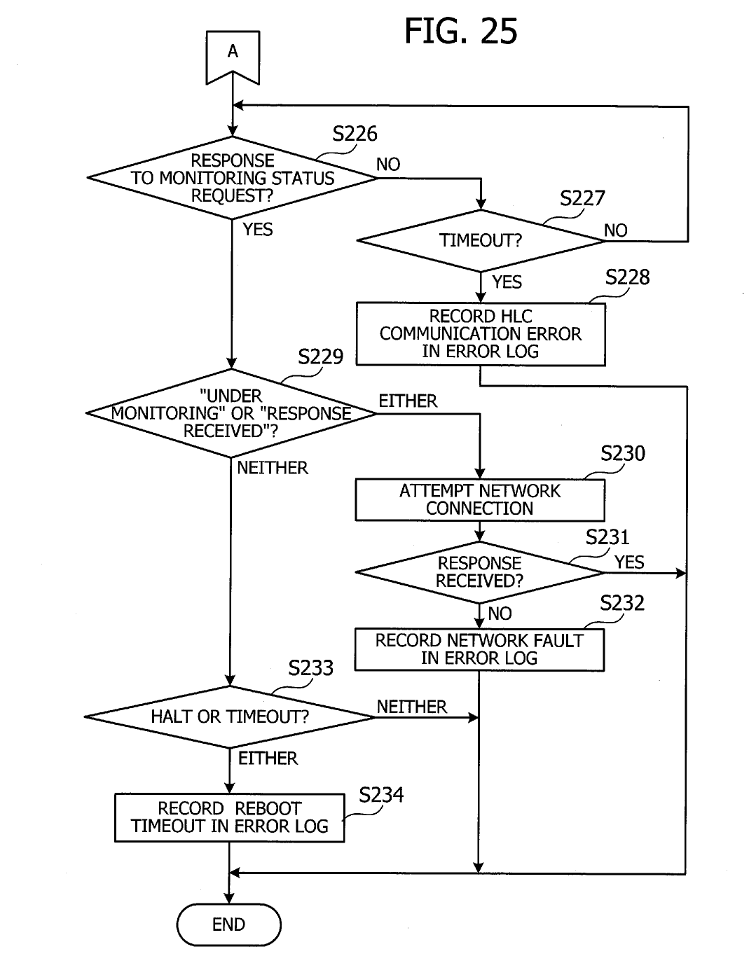

Referring now to FIGS. 24 and 25, the following section will describe a process executed when a regular monitoring halt command is received. It is assumed in this description that the console unit 100 is to stop regular monitoring of the internal server monitoring unit 212.

FIG. 24 is the first half of a flowchart illustrating an exemplary procedure of regular monitoring management, which is initiated upon receipt of a regular monitoring halt command. The operation seen in FIG. 24 is described below in the order of step numbers.

(Step S221) In response to a regular monitoring halt command from the internal server monitoring unit 212, the regular monitoring unit 110 triggers a timer to measure the time waiting for cancellation of the halt. The regular monitoring unit 110 places a status value of “Monitoring in Halt” in the monitoring status record that the monitoring status storage unit 120 stores for the internal server monitoring unit 212.

(Step S222) The regular monitoring unit 110 determines whether a regular monitoring resume command is received from the internal server monitoring unit 212. If a regular monitoring resume command is received, the regular monitoring unit 110 makes a change to the monitoring status storage unit 120 by setting a status value of “Under Monitoring” in the monitoring status record corresponding to the internal server monitoring unit 212. The regular monitoring unit 110 then terminates the process.

(Step S223) The regular monitoring unit 110 determines whether a resume timeout limit has expired. For example, the regular monitoring unit 110 detects a timeout when the above-noted timer reaches a predetermined resume timeout limit. When this is the case, the regular monitoring unit 110 notifies the monitoring status control unit 130 of the timeout event and then proceeds to step S224. When the resume timeout limit has not yet been reached, the regular monitoring unit 110 returns to step S222.

(Step S224) In response to the notice of a timeout, the monitoring status control unit 130 sends a monitoring status request to the management control unit 211. This monitoring status request specifies the internal server monitoring unit 212 as a device under confirmation.

(Step S225) The monitoring status control unit 130 triggers a timer to measure the time consumed for obtaining monitoring status information. The monitoring status control unit 130 then proceeds to step S226 (see FIG. 25).

FIG. 25 is the second half of the flowchart illustrating an exemplary procedure of regular monitoring management. The operation seen in FIG. 25 is described below in the order of step numbers.

(Step S226) The monitoring status control unit 130 determines whether a response to the monitoring status request has been received. If there has been a response, the monitoring status control unit 130 advances step S229. If not, the monitoring status control unit 130 proceeds to step S227.

(Step S227) As there has been no response to the monitoring status request, the monitoring status control unit 130 determines whether a response timeout limit is reached. For example, the monitoring status control unit 130 detects a timeout when the above-noted timer for monitoring status information reaches a predetermined response timeout limit. When this is the case, the monitoring status control unit 130 advances step S228. When the response timeout limit has not yet been reached, the monitoring status control unit 130 goes back to step S226.

(Step S228) Since the response timeout limit has been reached, the monitoring status control unit 130 adds an error log in the error log storage unit 150 to record an HLC communication error. The monitoring status control unit 130 then terminates the illustrated process.

(Step S229) The monitoring status control unit 130 determines whether the obtained monitoring status information indicates “Under Monitoring” or “Response Received”. If either “Under Monitoring” or “Response Received” is indicated, the monitoring status control unit 130 advances to step S230. If the monitoring status indicates neither of them, the monitoring status control unit 130 proceeds to step S233.

(Step S230) The monitoring status control unit 130 attempts to set up a network connection with the internal server monitoring unit 212.

(Step S231) The monitoring status control unit 130 determines whether a response is received from the internal server monitoring unit 212 that indicates successful execution of a network connection. If such a response has been received, the monitoring status control unit 130 terminates the illustrated process. If there is no response, the monitoring status control unit 130 proceeds to step S232. The latter case is, for example, when no response is returned within a specific time limit after the attempt of network connection.

(Step S232) The monitoring status control unit 130 terminates the process after adding an error log in the error log storage unit 150 to record a network fault.

(Step S233) The monitoring status control unit 130 determines whether the obtained monitoring status record indicates “Monitoring in Halt” or “Monitoring Timeout.” If the monitoring status record indicates either “Monitoring in Halt” or “Monitoring Timeout,” the monitoring status control unit 130 advances to step S234. If the monitoring status record indicates neither of them, the monitoring status control unit 130 terminates the illustrated process.

(Step S234) The monitoring status control unit 130 terminates the process after adding an error log in the error log storage unit 150 to record a reboot timeout error.

The above-described techniques contribute to improved accuracy of operation monitoring of the internal server monitoring unit 212. For example, the console unit 100 may be able to avoid mistakenly detecting that the internal server monitoring unit 212 is down, when the real problem is a fault in the network between the console unit 100 and internal server monitoring unit 212.

For another example, the internal server monitoring unit 212, when rebooted, may fail to set up a network connection with the console unit 100. There is still a chance, however, that a network connection can be made from the console unit 100 to the internal server monitoring unit 212. According to the second embodiment, the console unit 100 attempts to set up a network connection with the internal server monitoring unit 212, upon expiration of a resume timeout limit of regular monitoring. If this attempt is successful, then the console unit 100 will probably be able to keep communicating with the internal server monitoring unit 212 properly. It is justifiable to ignore the former error when the console unit 100 is successful in establishing a network connection.

### (c) Other Embodiments and Variations

The above description of the second embodiment has presented an example in which the internal server monitoring unit 212 is rebooted. The described processing is similarly applied to other cases in which the console unit 100 or management control unit 211 is rebooted.

The above second embodiment is configured to retrieve a monitoring status record from the management control unit 211 when no regular monitoring resume command is received from the internal server monitoring unit 212 within a given timeout limit. The same action may be taken when a timeout occurs with respect to other information. For example, the console unit 100 may retrieve a monitoring status record from the management control unit 211 when no response to its regular monitoring is received from the internal server monitoring unit 212 within a given timeout limit. The retrieved monitoring status record may indicate that the internal server monitoring unit 212 is operating properly. In this case, the console unit 100 suspects the presence of a network fault between the console unit 100 and internal server monitoring unit 212. The retrieved monitoring status record may otherwise indicate that the internal server monitoring unit 212 is down. In this case, the console unit 100 recognizes the presence of a failure in the internal server monitoring unit 212 itself.

Regular monitoring may be performed in a passive way, as in the management control unit 211. Such passive monitoring devices may be configured to obtain a monitoring status record from another monitoring device (e.g., internal server monitoring unit 212) when a timeout limit is expired for regular monitoring commands from an active monitoring device (e.g., console unit 100).

While the above-described second embodiment includes three devices configured to monitor each other's operation, it is also possible to implement such a mutual monitoring mechanism with four or more participating devices. In that case, two or more devices may be rebooted at the same time. Those rebooted devices are monitored by two non-booted devices in the way described in the second embodiment.

The console unit 100 in the above-described is configured to set up a network connection with the internal server monitoring unit 212 when the monitoring status information obtained from the management control unit 211 indicates that the internal server monitoring unit 212 is in a normal state, namely, “Under Monitoring” or “Response Received.” This network connection by the console unit 100 may, however, be executed at other times. For example, the console unit 100 may attempt a network connection before a monitoring status request is sent upon expiration of a resume timeout limit of regular monitoring. If this connection is successfully made with the internal server monitoring unit 212, it permits the console unit 100 to learn that the internal server monitoring unit 212 is operating properly, without transmitting a monitoring status request. In other words, the console unit 100 can avoid sending superfluous monitoring status requests to the management control unit 211.

The functions of the above-described embodiments may be implemented as a computer application. That is, the functions of the foregoing information processing apparatus 1, console unit 100, management control unit 211, and internal server monitoring unit 212 may be provided as one or more computer programs describing what they are supposed to do. A computer system executes those programs to provide the processing functions discussed in the preceding sections. The programs may be encoded in a computer-readable medium. Such computer-readable media include magnetic storage devices, optical discs, magneto-optical storage media, semiconductor memory devices, and other tangible storage media. Magnetic storage devices include HDDs, flexible disks (FD), and magnetic tapes, for example. Optical disc media include DVD, DVD-RAM, CD-ROM, CD-RW, and others. Magneto-optical storage media include magneto-optical discs (MO), for example.

Portable storage media, such as DVD and CD-ROM, are used for distribution of program products. Network-based distribution of software programs may also be possible, in which case several master program files are made available on a server computer for downloading to other computers via a network.

For example, a computer stores various software components in its local storage device, which have previously been installed from a portable storage medium or downloaded from a server computer. The computer executes the programs read out of its local storage device, thereby performing the programmed functions. Where appropriate, the computer may execute program codes read out of a portable storage medium, without installing them in the local storage device. Another alternative method is that the computer dynamically downloads programs from a server computer when they are demanded and executes them upon delivery.

It is further noted that the above processing functions may be executed wholly or partly by a digital signal processor (DSP), application-specific integrated circuit (ASIC), programmable logic device (PLD), or other electronic circuits, or their combinations.

Various embodiments and their variations have been discussed above. According to an aspect of those embodiments, the proposed techniques enable more accurate operation monitoring of target devices.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A computer-readable storage medium storing a program which causes a computer to perform a procedure comprising:
measuring a waiting time for information that is expected to be received from a target device connected via a network;
sending, upon expiration of a time limit without receiving the expected information, a query to a monitoring device monitoring the target device to request operational status information of the target device; and
determining whether the target device is faulty or there is a fault in the network between the computer and target device, based on the operational status information received from the monitoring device.

2. The computer-readable storage medium according to claim 1, wherein the procedure further comprises:
attempting to set up a connection with the target device over the network, when the determining has made a determination that there is a fault in the network; and
withdrawing the determination that there is a fault in the network, when the connection with the target device is set up successfully.

3. The computer-readable storage medium according to claim 1, wherein the information expected to be received from the target device is a regular monitoring resume command, and
wherein the procedure further comprises:
performing regular monitoring that regularly checks whether the target device is operating properly;
stopping the regular monitoring, and starting the measuring of the waiting time of the information, upon receipt of a regular monitoring halt command from the target device; and
resuming the regular monitoring of the target device upon receipt of the regular monitoring resume command.

4. The computer-readable storage medium according to claim 3, wherein the procedure further comprises:
attempting to set up a connection with the target device over the network, when the determining has made a determination that there is a fault in the network; and
resuming the regular monitoring of the target device, when the connection with the target device is set up successfully.

5. The computer-readable storage medium according to claim 1, wherein the procedure further comprises:
storing information in a storage device to record a result of the determining whether the target device is faulty or there is a fault in the network between the computer and target device.

6. The computer-readable storage medium according to claim 1, wherein:
the determining determines that the target device is faulty, when a response received from the monitoring device indicates that the target device has an abnormality; and
the determining determines that there is a fault in the network between the computer and target device, when the response received from the monitoring device indicates that the target device is operating properly.

7. An information processing apparatus comprising a processor configured to perform a procedure including:
measuring a waiting time for information that is expected to be received from a target device connected via a network;
sending, upon expiration of a time limit without receiving the expected information, a query to a monitoring device monitoring the target device to request operational status information of the target device; and
determining whether the target device is faulty or there is a fault in the network between the computer and target device, based on the operational status information received from the monitoring device.

8. A monitoring method comprising:
measuring, by a processor, a waiting time for information that is expected to be received from a target device connected via a network;
sending, by the processor, upon expiration of a time limit without receiving the expected information, a query to a monitoring device monitoring the target device to request operational status information of the target device; and
determining, by the processor, whether the target device is faulty or there is a fault in the network between the computer and target device, based on the operational status information received from the monitoring device.
